(19) United States
(12) Patent Application Publication
(10) Pub. No.: US 2017/0355907 A1
(43) Pub. Date: Dec. 14, 2017

(54) POLYMERIZABLE LIQUID CRYSTAL COMPOSITION, AND OPTICALLY ANISOTROPIC BODY, PHASE DIFFERENCE FILM, ANTIREFLECTION FILM, AND LIQUID CRYSTAL DISPLAY ELEMENT PRODUCED USING COMPOSITION

(71) Applicant: DIC Corporation, Tokyo (JP)

(72) Inventors: Kouichi Endo, Kita-adachi-gun (JP); Yasuhiro Kuwana, Kita-adachi-gun (JP); Hidetoshi Nakata, Kita-adachi-gun (JP); Mika Yamamoto, Kita-adachi-gun (JP); Kazuaki Hatsusaka, Kita-adachi-gun (JP)

(73) Assignee: DIC Corporation, Tokyo (JP)

(21) Appl. No.: 15/542,744

(22) PCT Filed: Dec. 10, 2015
(86) PCT No.: PCT/JP2015/084648

§ 371 Date: Jul. 11, 2017

(30) Foreign Application Priority Data
Jan. 13, 2015 (JP) 2015-004144

(51) Int. Cl. C09K 19/20; C09K 19/12; G02B 1/113

(52) U.S. Cl. CPC C09K 19/2007; C09K 19/12; C09K 2019/122; G02B 1/113; C09K 2019/2035

(57) ABSTRACT

The present invention provides a polymerizable liquid crystal composition including a specific polymerizable compound and a fluorosurfactant having specific polyoxyalkylene skeleton and molecular weight. Also, an optically anisotropic body, a phase difference film, an antireflection film, and a liquid crystal display device, which are produced by using the polymerizable liquid crystal composition according to the present invention, are provided. The present invention is useful because three properties, that is, leveling properties of the surface of an optically anisotropic body, offset to a base material, and alignment properties of a liquid crystal can be improved at the same time in the case where the optically anisotropic body is produced by photopolymerizing the polymerizable liquid crystal composition.

### TECHNICAL FIELD

The present invention relates to a polymerizable liquid crystal composition that is a useful constituent member of an optically anisotropic body used for liquid crystal devices, displays, optical parts, colorants, security markings, laser emission members, and optically compensating liquid crystal displays and the like, and to an optically anisotropic body, a phase difference film, an antireflection film, and a liquid crystal display element composed of the composition.

### BACKGROUND ART

A polymerizable liquid crystal composition is a useful constituent member of an optically anisotropic body. The optically anisotropic body is used for, for example, a phase difference film and an antireflection film, which are applied to various liquid crystal displays. The optically anisotropic body containing a liquid crystal substance as a constituent component is produced by coating a substrate with a polymerizable liquid crystal composition and curing the polymerizable liquid crystal composition, in an aligned state, by performing heating or radiating active energy rays. In order to obtain stable uniform optical characteristics, it is necessary that the uniformly aligned structure of liquid crystal molecules in the liquid crystal state be semipermanently fixed.

Up to now, polymerizable liquid crystal compositions containing a surfactant so as to improve the applicability to a substrate have been disclosed (PTL 1 and 2). Also, roll-to-roll coating of a film base material has been performed as an efficient and economical coating method in recent years. However, in this method, a coated film surface and the base material come into contact with each other due to take-up of the film base material after coating and, as a result, there is a problem in that defective appearance of a coating film or a base material frequently occurs because of transfer of a surfactant in the coating film due to the contact. According to the methods in the above-described literature, applicability to the substrate is improved and occurrence of variations in film thickness can be reduced, even though there is no description of the defective appearance (offset properties) problem resulting from the contact between the coated film surface after the coating and the base material and no description of a measure thereto.

### CITATION LIST

### Patent Literature

PTL 1: Japanese Unexamined Patent Application Publication No. 08-231958

PTL 2: Japanese Unexamined Patent Application Publication No. 2000-105315

### SUMMARY OF INVENTION

### Technical Problem

An issue to be addressed by the present invention is the provision of a polymerizable liquid crystal composition that can solve the above-described problem by improving two characteristics of leveling properties of the surface of an optically anisotropic body and offset properties at the same time in the case where the optically anisotropic body is produced by photopolymerizing the polymerizable liquid crystal composition.

### Solution to Problem

Regarding the present invention, in order to solve the above-described problem, a polymerizable liquid crystal composition has attracted a great deal of attention and repeated research has been performed. As a result, the present invention was realized.

That is, the present invention provides a polymerizable liquid crystal composition including at least one polymerizable compound denoted by general formula (I)

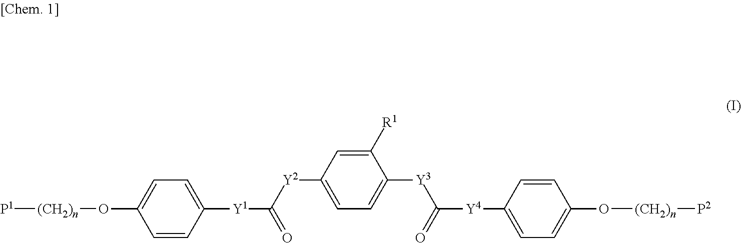

(n represents an integer of 1 to 10, each of P¹ and P² represents an acryloyl group, a methacryloyl group, a vinyl ether group, an aliphatic epoxy group, or an alicyclic epoxy group, each of Y¹, Y², Y³, and Y⁴ represents a single bond, —O—, —CH₂—, —CH₂CH₂—, —OCH₂CH₂—, or —CH₂CH₂O—, and R¹ represents a hydrogen atom, a methyl group, an ethyl group, a methoxy group, an ethoxy group, or —COO—CH₂—C₆H₅) and at least one fluorosurfactant selected from the group consisting of copolymers (III), each of which has a weight average molecular weight of 2,500 to 30,000 and is a copolymer produced by copolymerizing, as indispensable monomers, a polymerizable monomer denoted by general formula (B), the polymerizable monomer having a solubility parameter (SP value) of 8.9 to 10.5 (cal/cm³)^{0.5} and satisfying formula (1) described below

1.00<100×(s+t+u)/MB<2.10 (1)

(s represents an integer of 1 or more, each of t and u represents an integer of 0 or more, and MB represents the molecular weight of the polymerizable monomer denoted by general formula (B))
and a polymerizable monomer containing a fluorine atom.

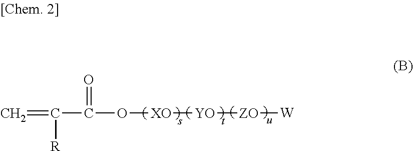

(in the formula, R represents a hydrogen atom or a methyl group, each of X, Y, and Z represents an alkylene group, s represents an integer of 1 or more, each of t and u represents an integer of 0 or more, and W represents a hydrogen atom, an alkyl group having a carbon atom number of 1 to 6, or an aryl group)

In addition, an optically anisotropic body including the polymerizable liquid crystal composition according to the present invention is provided.

### Advantageous Effects of Invention

An optically anisotropic body having excellent surface smoothness and exhibiting low offset properties from a liquid crystal coating film surface can be produced by using the polymerizable liquid crystal composition according to the present invention.

### DESCRIPTION OF EMBODIMENTS

The most favorable form of a polymerizable liquid crystal composition according to the present invention will be described below. In the present invention, “liquid crystal” with respect to the polymerizable liquid crystal composition refers to liquid crystallinity being exhibited after the polymerizable liquid crystal composition is applied to the base material and drying is performed. In this regard, the polymerizable liquid crystal composition can be made into a polymer (made into a film) by being subjected to polymerization treatment in which irradiation with light, e.g., ultraviolet rays, or heating is performed.

(Difunctional Polymerizable Compound)

The polymerizable liquid crystal composition according to the present invention contains at least one difunctional polymerizable compound denoted by general formula (I),

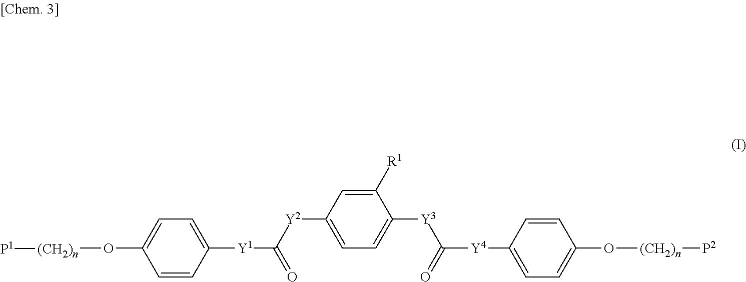

and preferably contains at least two types. In this regard, n represents an integer of 1 to 10, preferably an integer of 1 to 9, and further preferably an integer of 2 to 8, each of Y¹, Y², Y³, and Y⁴ represents a single bond, —O—, —CH₂—, —CH₂CH₂—, —OCH₂CH₂—, or —CH₂CH₂O—, and preferably a single bond, —O—, —OCH₂CH₂—, or —CH₂CH₂O—, R¹ represents a hydrogen atom, a methyl group, an ethyl group, a methoxy group, an ethoxy group, or —COO—CH₂—C₆H₅, and preferably a hydrogen atom, a methyl group, or —COO—CH₂—C₆H₅, and each of P² and P² represents an acryloyl group, a methacryloyl group, a vinyl ether group, an aliphatic epoxy group, or an alicyclic epoxy group, preferably an acryloyl group, a methacryloyl group, an aliphatic epoxy group, or an alicyclic epoxy group, and particularly preferably an acryloyl group or a methacryloyl group. Specifically, it is particularly preferable that the compounds denoted by formula (I-1-1) to formula (I-1-7) described below be used.

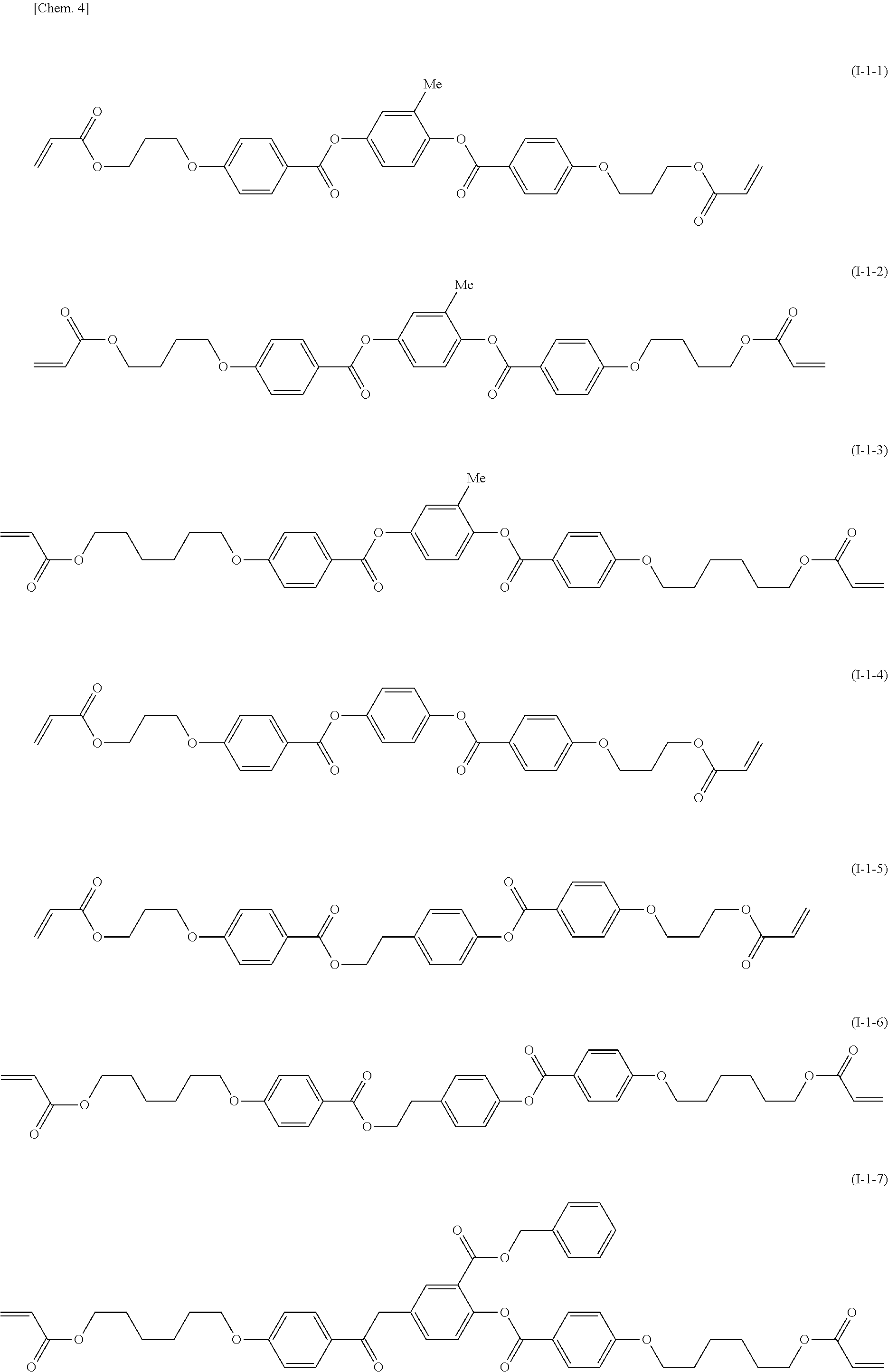

According to the present invention, the polymerizable liquid crystal composition containing at least one of these difunctional polymerizable compounds is preferable because the heat resistance and the moist-heat resistance of a cured coating film are improved.

Regarding the content of the difunctional polymerizable compound denoted by general formula (I) in the case where a chiral compound described later is included, the content is preferably 40 to 80 percent by mass of the total amount of the polymerizable compound and chiral compound used, the content is more preferably 45 to 75 percent by mass, and the content is particularly preferably 50 to 70 percent by mass.

Meanwhile, in the case where a chiral compound is not used, the content of the difunctional polymerizable compound denoted by general formula (I) is preferably 10 to 100 percent by mass of the total amount of polymerizable compounds used, the content is more preferably 15 to 100 percent by mass, and the content is particularly preferably 20 to 100 percent by mass.

In addition, the polymerizable liquid crystal composition according to the present invention can contain a difunctional polymerizable compound other than the difunctional polymerizable compound denoted by general formula (I) described above. Specifically, a compound that is used is a compound denoted by general formula (I-2)

[Chem. 5]

P-(Sp)ₘ-MG-(Sp)ₘ-P (I-2)

(in the formula, P represents a polymerizable functional group,
Sp represents a spacer group having a carbon atom number of 0 to 18,
each m represents 0 or 1, and
MG represents a mesogenic group or a mesogenic support group, where the compound denoted by general formula (I) described above is excluded).

More specifically, a compound that is used is a compound denoted by general formula (I-2), in which Sp represents an alkylene group (the alkylene group may include a substituent composed of at least one halogen atom or CN, and a CH₂ group or each of at least two CH₂ groups that are not adjacent to each other in the alkylene group may be substituted with —O—, —S—, —NH—, —N(CH₃)—, —CO—, —COO—, —OCO—, —OCOO—, —SCO—, —COS—, or —C≡C— in the form in which oxygen atoms are not directly bonded to each other) and MG is denoted by general formula (I-2-b)

[Chem. 6]

-Z0-(A1-Z1)ₙ-A2-Z2-A3-Z3 (I-2-b)

(in the formula, each of A1, A2, and A3 represents a 1,4-phenylene group, a 1,4-cyclohexylene group, a 1,4-cyclohexenyl group, a tetrahydropyran-2,5-diyl group, a 1,3-dioxane-2,5-diyl group, a tetrahydrothiopyran-2,5-diyl group, a 1,4-bicyclo(2,2,2)octylene group, a decahydronaphthalene-2,6-diyl group, a pyridine-2,5-diyl group, a pyrimidine-2,5-diyl group, a pyrazine-2,5-diyl group, a thiophene-2,5-diyl group-, a 1,2,3,4-tetrahydronaphthalene-2,6-diyl group, a 2,6-naphthylene group, a phenanthrene-2,7-diyl group, a 9,10-dihydrophenanthrene-2,7-diyl group, a 1,2,3,4,4a,9,10a-octahydrophenanthrene-2,7-diyl group, a 1,4-naphthylene group, a benzo[1,2-b:4,5-b′]dithiophene-2,6-diyl group, a benzo[1,2-b:4,5-b′]diselenophene-2,6-diyl group, a [1]benzothieno[3,2-b]thiophene-2,7-diyl group, a [1]benzoselenopheno[3,2-b]selenophene-2,7-diyl group, or a fluorene-2,7-diyl group and may have at least one substituent composed of F, Cl, CF₃, OCF₃, a CN group, an alkyl group having a carbon atom number of 1 to 8, an alkoxy group, an alkanoyl group, an alkanoyloxy group, an alkenyl group having a carbon atom number of 2 to 8, an alkenyloxy group, an alkenoyl group, or an alkenoyloxy group, each of Z0, Z1, Z2, and Z3 represents —COO—, —OCO—, —CH₂CH₂—, —OCH₂—, —CH₂O—, —CH═CH—, —C≡C—, —CH═CHCOO—, —OCOCH═CH—, —CH₂CH₂COO—, —CH₂CH₂OCO—, —COOCH₂CH₂—, —OCOCH₂CH₂—, —CONH—, —NHCO—, an alkyl group that has a carbon atom number of 2 to 10 and may have a halogen atom, or a single bond, and n represents 0, 1, or 2).

Regarding the polymerizable functional group, a vinyl group, a vinyl ether group, an acryl group, a (meth)acryl group, a glycidyl group, an oxetanyl group, a maleimide group, and a thiol group are preferable. From the viewpoint of productivity, a vinyl ether group, an acryl group, a (meth)acryl group, and a glycidyl group are further preferable, and an acryl group and a (meth)acryl group are particularly preferable.

Examples of the compounds are shown below but the compounds are not limited to these examples.

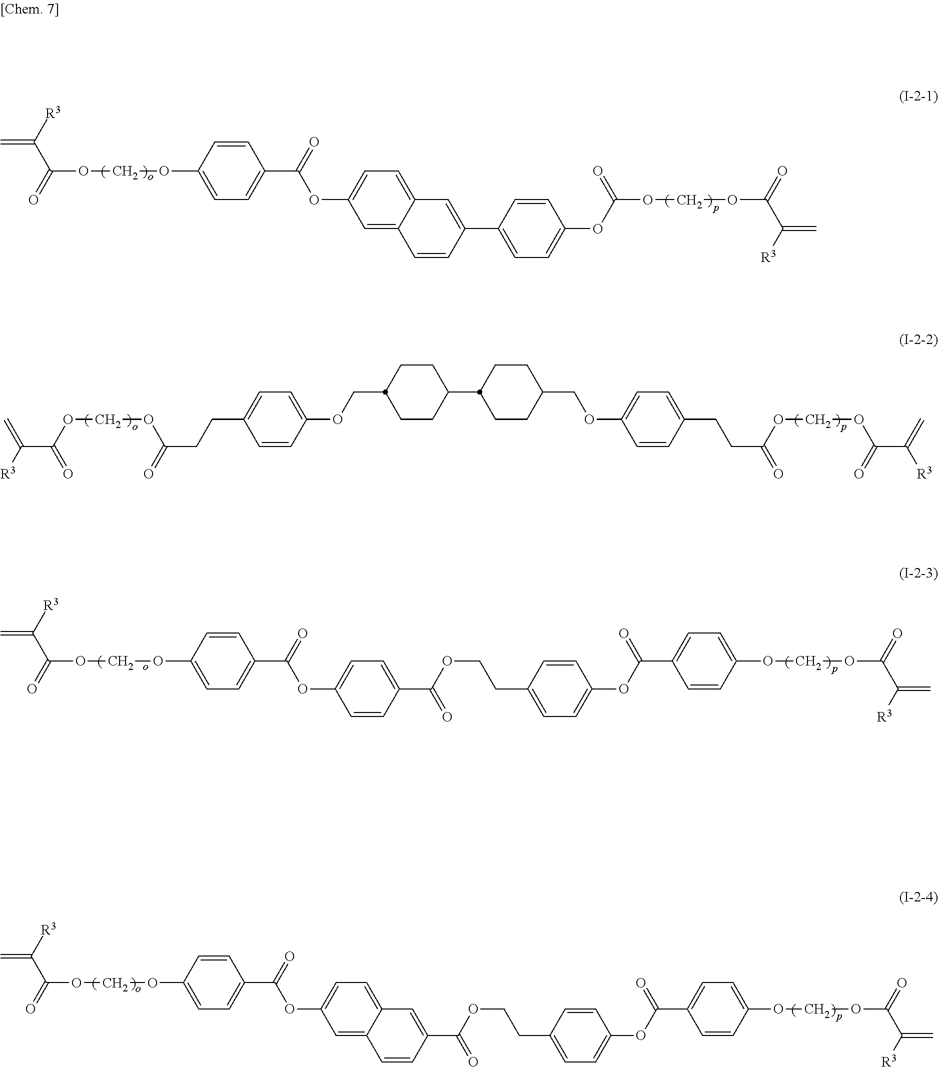

(in the formula, each of o and p represents an integer of 1 to 18, R³ represents a hydrogen atom, a halogen atom, an alkoxy group having a carbon number of 1 to 6, or a cyano group, and in the case where these groups are alkoxy groups having a carbon number of 1 to 6, all of the alkoxy groups may be unsubstituted or the alkoxy groups may include a substituent composed of at least one halogen atom) These compounds can be used alone, or at least two types can be used in combination.

Regarding the content of the difunctional polymerizable compound other than the difunctional polymerizable compound denoted by general formula (I) described above, the content is preferably 0 to 10 percent by mass of the total amount of the polymerizable compound and chiral compound used, the content is more preferably 0 to 8 percent by mass, and the content is particularly preferably 0 to 5 percent by mass.

Meanwhile, in the case where a chiral compound is not used, the content of the difunctional polymerizable compound other than the difunctional polymerizable compound denoted by general formula (I) described above is preferably 0 to 10 percent by mass of the total amount of polymerizable compounds used, the content is more preferably 0 to 8 percent by mass, and the content is particularly preferably 0 to 5 percent by mass.

(Monofunctional Polymerizable Compound)

In addition, the polymerizable liquid crystal composition according to the present invention may contain a monofunctional polymerizable compound having one polymerizable functional group in the molecule. Regarding the monofunctional polymerizable compound, at least one monofunctional polymerizable compound selected from the group consisting of compounds denoted by general formula (II-1)

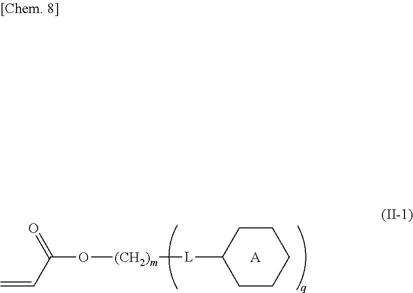

can be used. In general formula (II-1), m represents an integer of 0 to 10, preferably an integer of 0 to 8, and further preferably an integer of 0 to 6, q represents 2 or 3, each L represents a single bond, —O—, —CO—, —COO—, —OCO—, or —N═N—, and preferably a single bond, —O—, —COO—, or —N═N—, each A represents a 1,4-phenylene group, a 1,6-naphthalene group, or a 1,4-cyclohexylene group, and each of the 1,4-phenylene group, the 1,6-naphthalene group, and the 1,4-cyclohexylene group, that is A, may include a substituent composed of a fluorine atom, a chlorine atom, a CF₃ group, a OCF₃ group, a cyano group, an alkyl group having a carbon atom number of 1 to 8, an alkoxy group, an alkanoyl group, or an alkanoyloxy group.

The compound denoted by general formula (II-1) is preferably a compound denoted by general formula (II-1-a) described below.

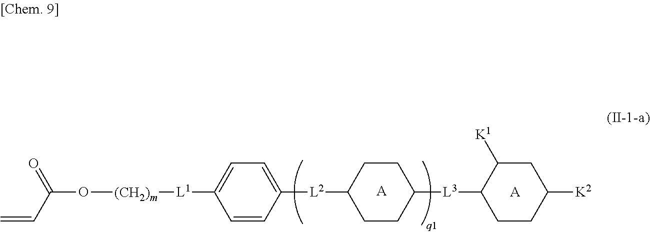

In general formula (II-1-a), m represents an integer of 0 to 10, preferably an integer of 0 to 8, and further preferably an integer of 0 to 6, q¹ represents 0 or 1, each of L¹, L², and L³ represents a single bond, —O—, —CO—, —COO—, —OCO—, or —N═N—, and preferably a single bond, —O—, —COO—, or —N═N—, each A represents a 1,4-phenylene group, a 1,6-naphthalene group, or a 1,4-cyclohexylene group and preferably a 1,4-phenylene group, a 1,6-naphthalene group, or a 1,4-cyclohexyl group, and each of K¹ and K² represents a hydrogen atom, a fluorine atom, a chlorine atom, a CF₃ group, a OCF₃ group, a cyano group, an alkyl group having a carbon atom number of 1 to 8, an alkoxy group, an alkanoyl group, or an alkanoyloxy group and preferably a hydrogen atom, a cyano group, an alkyl group having a carbon atom number of 1 to 8, or an alkoxy group.

More specifically, compounds denoted by formula (II-1-1) to formula (II-1-7) can be used.

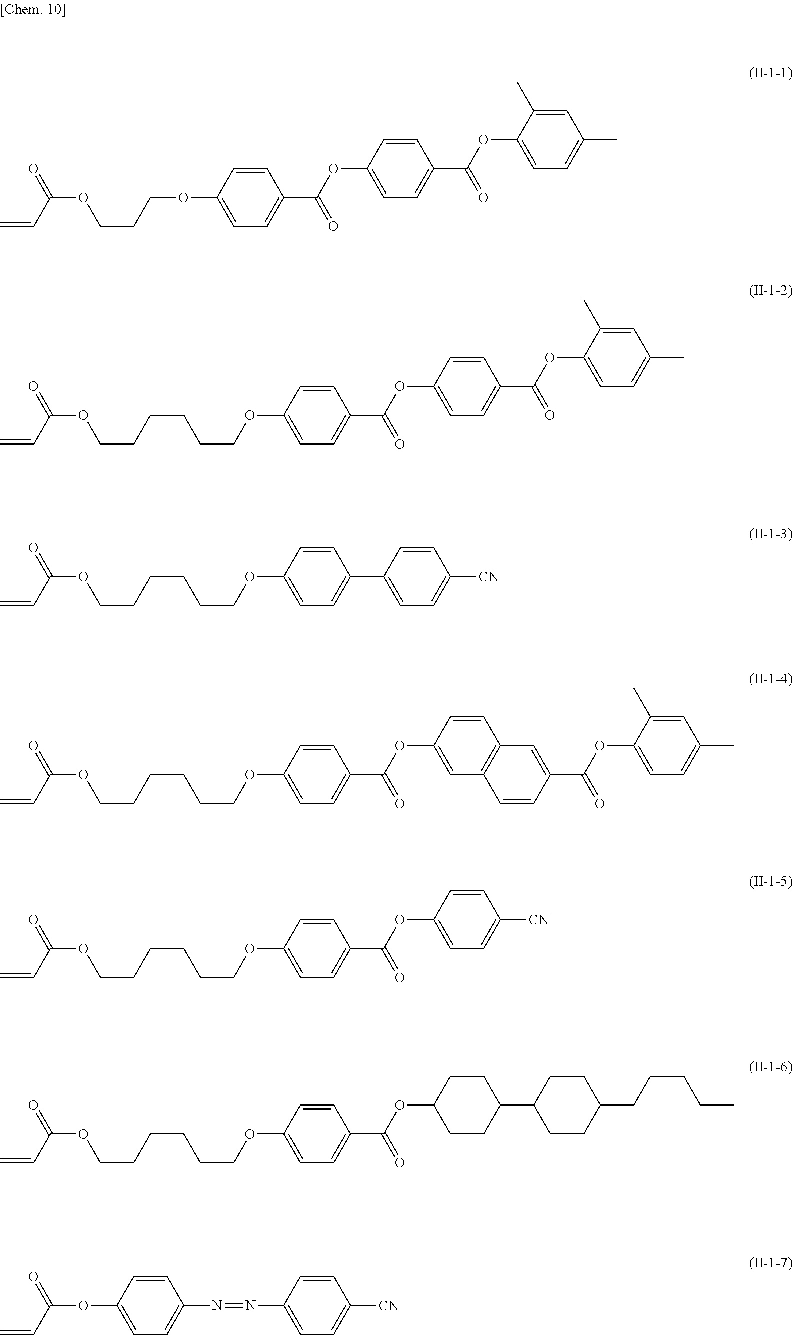

In particular, it is preferable that at least one of or both the compound denoted by general formula (II-1-1) and the compound denoted by general formula (II-1-2) be used because an optically anisotropic body having excellent alignment properties may be obtained. Also, it is preferable that the compound denoted by general formula (II-1-3) be included because an optically anisotropic body having excellent alignment properties may be obtained.

The content of the monofunctional polymerizable compound having one polymerizable functional group in the molecule is preferably 10 to 60 percent by mass of the total amount of the polymerizable compound and chiral compound used, more preferably 15 to 50 percent by mass, and particularly preferably 20 to 45 percent by mass.

Meanwhile, in the case where a chiral compound is not used, the content of the monofunctional polymerizable compound having one polymerizable functional group in the molecule is preferably 0 to 90 percent by mass of the total amount of the polymerizable compound used, more preferably 0 to 85 percent by mass, and particularly preferably 0 to 80 percent by mass.

The content of the compound denoted by general formula (II-1) is preferably 10 to 60 percent by mass of the total amount of the polymerizable compound and chiral compound used, more preferably 15 to 55 percent by mass, and particularly preferably 20 to 45 percent by mass.

Meanwhile, in the case where a chiral compound is not used, the content of the compound denoted by general formula (II-1) is preferably 0 to 90 percent by mass of the total amount of the polymerizable compounds used, more preferably 0 to 85 percent by mass, and particularly preferably 0 to 80 percent by mass.

The polymerizable liquid crystal composition according to the present invention can contain a monofunctional polymerizable compound other than the monofunctional polymerizable compound denoted by general formula (II-1) described above. Specifically, a compound that is used is a compound denoted by general formula (II-2)

[Chem. 11]

P-(Sp)ₘ-MG-R¹ (II-2)

(in the formula, P represents a polymerizable functional group,
Sp represents a spacer group having a carbon atom number of 0 to 18,
m represents 0 or 1,
MG represents a mesogenic group or a mesogenic support group, and
R¹ represents a halogen atom, a cyano group, or an alkyl group having a carbon atom number of 1 to 18, the alkyl group may include a substituent composed of at least one halogen atom or CN, and a CH₂ group or each of at least two CH₂ groups that are not adjacent to each other in the alkyl group may be substituted with —O—, —S—, —NH—, —N(CH₃)—, —CO—, —COO—, —OCO—, —OCOO—, —SCO—, —COS—, or —C≡C— in the form in which oxygen atoms are not directly bonded to each other, where the compound denoted by general formula (II-1) described above is excluded).

More specifically, a compound that is used is a compound denoted by general formula (II-2), in which Sp represents an alkylene group, (the alkylene group may include a substituent composed of at least one halogen atom or CN, and a CH₂ group or each of at least two CH₂ groups that are not adjacent to each other in the alkylene group may be substituted with —O—, —S—, —NH—, —N(CH₃)—, —CO—, —COO—, —OCO—, —OCOO—, —SCO—, —COS—, or —C≡C— in the form in which oxygen atoms are not directly bonded to each other) and MG is denoted by general formula (II-2-b)

[Chem. 12]

-Z0-(A1-Z1)ₙ-A2-Z2-A3-Z3 (II-2-b)

(in the formula, each of A1, A2, and A3 represents a 1,4-phenylene group, a 1,4-cyclohexylene group, a 1,4-cyclohexenyl group, a tetrahydropyran-2,5-diyl group, a 1,3-dioxane-2,5-diyl group, a tetrahydrothiopyran-2,5-diyl group, a 1,4-bicyclo(2,2,2)octylene group, a decahydronaphthalene-2,6-diyl group, a pyridine-2,5-diyl group, a pyrimidine-2,5-diyl group, a pyrazine-2,5-diyl group, a thiophene-2,5-diyl group-, a 1,2,3,4-tetrahydronaphthalene-2,6-diyl group, a 2,6-naphthylene group, a phenanthrene-2,7-diyl group, a 9,10-dihydrophenanthrene-2,7-diyl group, a 1,2,3,4,4a,9,10a-octahydrophenanthrene-2,7-diyl group, a 1,4-naphthylene group, a benzo[1,2-b:4,5-b′]dithiophene-2,6-diyl group, a benzo[1,2-b:4,5-b′]diselenophene-2,6-diyl group, a [1]benzothieno[3,2-b]thiophene-2,7-diyl group, a [1]benzoselenopheno[3,2-b]selenophene-2,7-diyl group, or a fluorene-2,7-diyl group and may have at least one substituent composed of F, Cl, CF₃, OCF₃, a CN group, an alkyl group having a carbon atom number of 1 to 8, an alkoxy group, an alkanoyl group, an alkanoyloxy group, an alkenyl group having a carbon atom number of 2 to 8, an alkenyloxy group, an alkenoyl group, or an alkenoyloxy group, each of Z0, Z1, Z2, and Z3 represents —COO—, —OCO—, —CH₂CH₂—, —OCH₂—, —CH₂O—, —CH═CH—, —C≡C—, —CH═CHCOO—, —OCOCH═CH—, —CH₂CH₂COO—, —CH₂CH₂OCO—, —COOCH₂CH₂—, —OCOCH₂CH₂—, —CONH—, —NHCO—, an alkyl group that has a carbon atom number of 2 to 10 and may have a halogen atom, or a single bond, and n represents 0, 1, or 2).

Regarding the polymerizable functional group, a vinyl group, a vinyl ether group, an acryl group, a (meth)acryl group, a glycidyl group, an oxetanyl group, a maleimide group, and a thiol group are preferable. From the viewpoint of productivity, a vinyl ether group, an acryl group, a (meth)acryl group, and a glycidyl group are further preferable, and an acryl group and a (meth)acryl group are particularly preferable.

Examples of the compounds are shown below but the compounds are not limited to these examples.

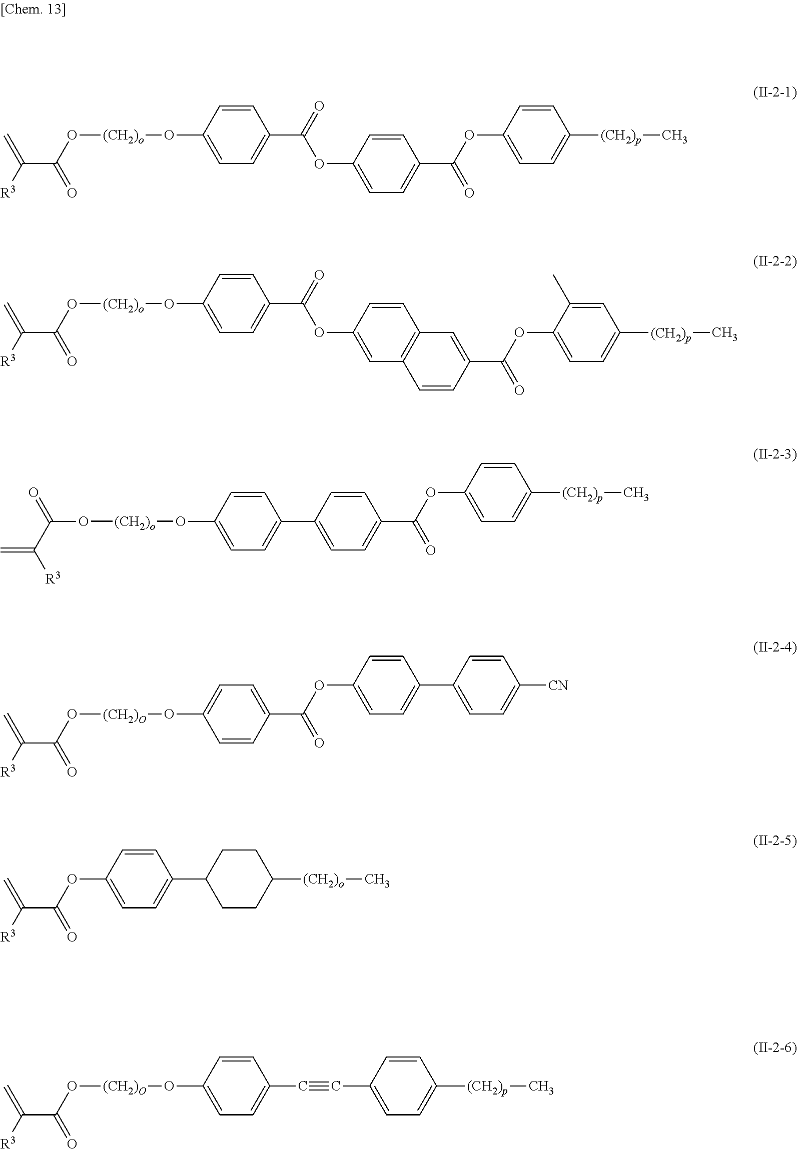

(in the formula, each of o and p represents an integer of 1 to 18, R³ represents a hydrogen atom, a halogen atom, an alkoxy group having a carbon number of 1 to 6, or a cyano group, and in the case where these groups are alkoxy groups having a carbon number of 1 to 6, all of the alkoxy groups may include no substituent or the alkoxy groups may include a substituent composed of at least one halogen atom) These compounds can be used alone, or at least two types can be used in combination.

Regarding the content of the monofunctional polymerizable compound other than the compound denoted by general formula (II-2) described above, the content is preferably 0 to 10 percent by mass of the total amount of the polymerizable compound and chiral compound used, the content is more preferably 0 to 8 percent by mass, and the content is particularly preferably 0 to 5 percent by mass.

Meanwhile, in the case where a chiral compound is not used, the content of the monofunctional polymerizable compound other than the compound denoted by general formula (II-2) described above is preferably 0 to 10 percent by mass of the total amount of polymerizable compounds used, the content is more preferably 0 to 8 percent by mass, and the content is particularly preferably 0 to 5 percent by mass.

Regarding the total content of the monofunctional polymerizable compound and the difunctional polymerizable compound in the polymerizable liquid crystal composition according to the present invention, the content is preferably 20 to 100 percent by mass of the total amount of polymerizable compounds used, the content is more preferably 40 to 100 percent by mass, and the content is particularly preferably 60 to 100 percent by mass.

(Chiral Compound)

A chiral compound may be mixed into the polymerizable liquid crystal composition according to the present invention for the purpose of obtaining a chiral nematic phase. Among chiral compounds, a compound having a polymerizable functional group in the molecule is particularly preferable. Regarding the polymerizable functional group in the chiral compound, an acryloyloxy group is particularly preferable. The amount of the chiral compound mixed has to be adjusted appropriately in accordance with the helical twisting power of the compound. The content is preferably 3 to 400% relative to the polymerizable compound used, the content is more preferably 3 to 300%, and the content is particularly preferably 3 to 200%.

Specific examples of chiral compounds can include compounds denoted by formulae (1-1) to (1-9).

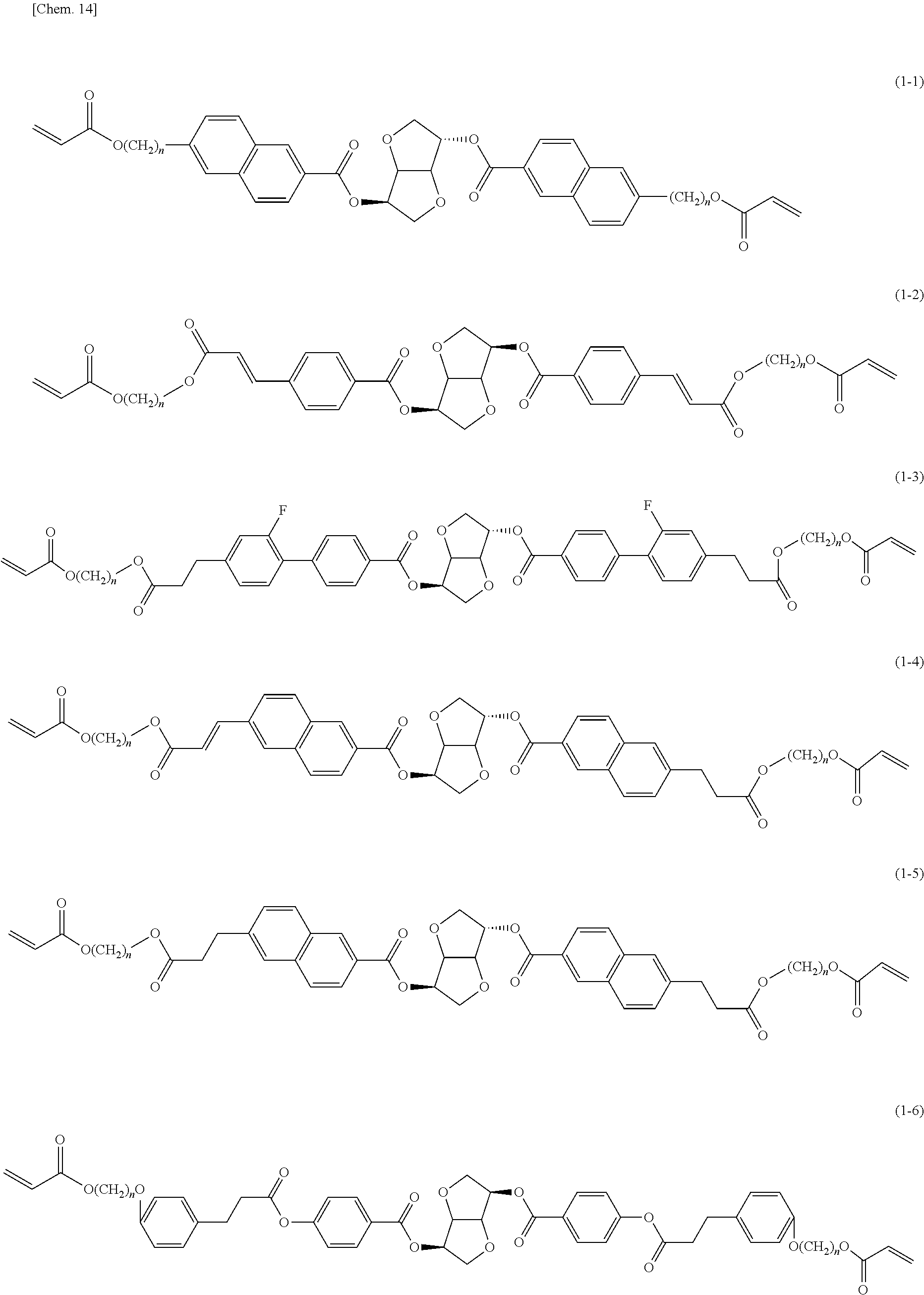

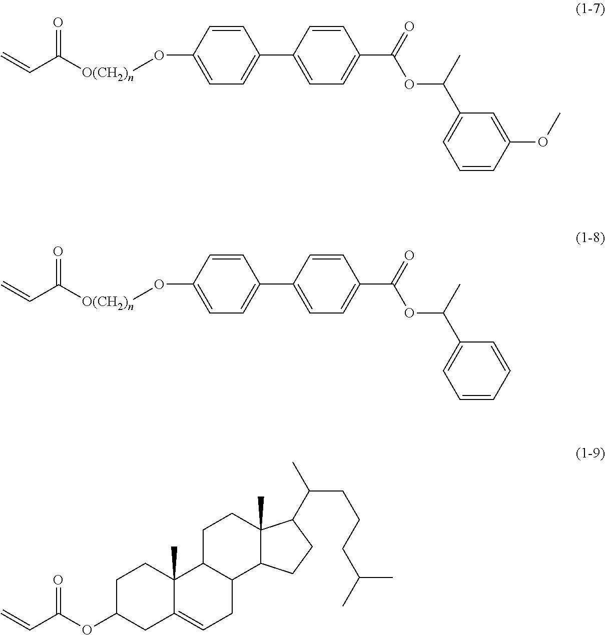

(in the formulae, n represents an integer of 0 to 12) In addition, specific examples of chiral compounds can further include compounds denoted by formulae (1-10) to (1-14).

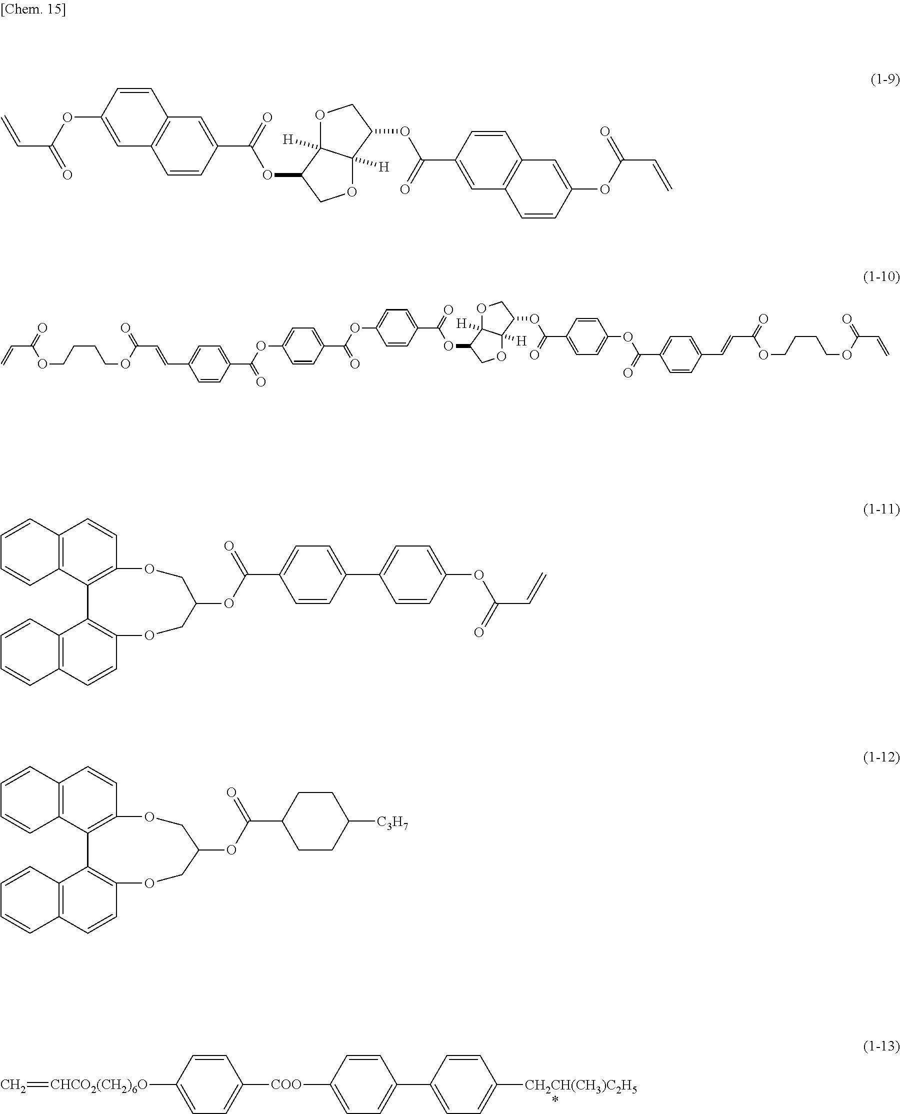

(Fluorosurfactant)

The polymerizable liquid crystal composition according to the present invention contains at least one fluorosurfactant selected from the group consisting of copolymers (III), each of which has a weight average molecular weight of 2,500 to 30,000 and is a copolymer produced by copolymerizing, as indispensable monomers, a polymerizable monomer denoted by general formula (B), the polymerizable monomer having a solubility parameter (SP value) of 8.9 to 10.5 (cal/cm³)^{0.5} and satisfying formula (1) described below

1.00<100×(s+t+u)/MB<2.10 (1)

(s represents an integer of 1 or more, each of t and u represents an integer of 0 or more, and MB represents the molecular weight of the polymerizable monomer denoted by general formula (B)),
and a polymerizable monomer containing a fluorine atom.

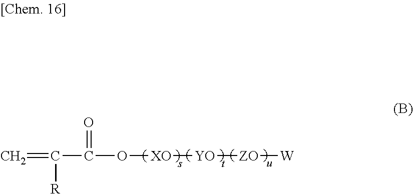

(in the formula, R represents a hydrogen atom or a methyl group, each of X, Y, and Z represents an alkylene group, s represents an integer of 1 or more, each of t and u represents an integer of 0 or more, and W represents a hydrogen atom, an alkyl group having a carbon atom number of 1 to 6, or an aryl group)

In the case where the fluorosurfactant is used, the polymerizable liquid crystal composition according to the present invention has excellent solution stability because good compatibility between the polymerizable compound and the fluorosurfactant is ensured and has excellent surface leveling properties when being made into an optically anisotropic body.

It is preferable that the fluorosurfactant be composed of only carbon atom, hydrogen atom, oxygen atom, fluorine atom, and nitrogen atom. It is considered that the compatibility between the surfactant composed of these atoms and the polymerizable compound is enhanced because these atoms are the same as the atoms constituting the structure (spacer (Sp) portion and mesogen (MG) portion) other than the end portion (end group) of the polymerizable compound used in the present invention.

In addition, it is preferable that the fluorosurfactant have a group denoted by —(XO)ₛ— (X represents an alkylene group having a carbon atom number of 1 to 10 and s represents an integer of 1 or more) because excellent surface smoothness (cissing resistance) is ensured when an optically anisotropic body is produced. Regarding the alkylene group represented by X, an ethylene group, a propylene group, a butylene group, and a tetramethylene group are preferable, and an ethylene group, a propylene group, and a butylene group are further preferable. In this regard, in the present invention, “butylene” refers to a branched alkylene having a carbon atom number of 4, and “tetramethylene” refers to a straight chain alkylene having a carbon atom number of 4.

(Polymerizable Monomer Denoted by General Formula (B))

The polymerizable monomer denoted by general formula (B) is as described below.

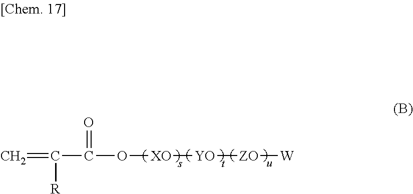

(in the formula, R represents a hydrogen atom or a methyl group, each of X, Y, and Z represents an alkylene group, s represents an integer of 1 or more, each of t and u represents an integer of 0 or more, and W represents a hydrogen atom, an alkyl group having a carbon atom number of 1 to 6, or an aryl group).

In general formula (B), each of X, Y, and Z represents an alkylene group, and the alkylene group may include a substituent. Specific examples of the —O—(XO)ₛ—(YO)ₜ—(ZO)ᵤ-portion include a polyoxypropylene in which the number s of repetitions of the unit is an integer of 3 or more, each of t and u is 0, and X is propylene, a polyoxybutylene in which the number s of repetitions of the unit is an integer of 3 or more, each of t and u is 0, and X is butylene, a polyoxytetramethylene in which the number s of repetitions of the unit is an integer of 3 or more, each of t and u is 0, and X is tetramethylene, a polyoxyalkylene which is a copolymer of ethylene oxide and propylene oxide and in which each of the number s of repetitions of the unit and the number t of repetitions of the unit is an integer of 1 or more, u is 0, X or Y is ethylene, and the other is propylene, a polyoxyalkylene which is a copolymer of propylene oxide and butylene oxide and in which each of the number s of repetitions of the unit and the number t of repetitions of the unit is an integer of 1 or more, u is 0, X or Y is propylene, and the other is butylene, a polyoxyalkylene which is a copolymer of ethylene oxide and tetrahydrofuran and in which each of the number s of repetitions of the unit and the number t of repetitions of the unit is an integer of 1 or more, u is 0, X or Y is ethylene, and the other is tetramethylene, a polyoxyalkylene which is a copolymer of propylene oxide and tetrahydrofuran and in which each of the number s of repetitions of the unit and the number t of repetitions of the unit is an integer of 1 or more, u is 0, X or Y is propylene, and the other is tetramethylene, and a polyoxyalkylene which is a copolymer of ethylene oxide, propylene oxide, and ethylene oxide and in which each of the number s of repetitions of the unit, the number t of repetitions of the unit, and the number u of repetitions of the unit is an integer of 1 or more, X and Z are ethylene, and Y is propylene.

Regarding the degree of polymerization, that is, the total of s, t, and u in general formula (B), of these polyoxyalkylenes are preferably 3 to 50, further preferably 3 to 45, and particularly preferably 3 to 40. In this regard, the repetition unit containing X, the repetition unit containing Y, and the repetition unit containing Z may be arranged at random or be arranged on a block basis.

Among the polymerizable monomers that are denoted by general formula (B) and have a polyoxyalkylene chain, polymerizable monomers having at least a polyoxypropylene chain, a polyoxybutylene chain, or a polyoxytetramethylene chain are preferable because more excellent cissing resistance is exhibited when being added to the polymerizable liquid crystal composition according to the present invention. The polymerizable monomers having at least a polyoxypropylene chain, a polyoxybutylene chain, or a polyoxytetramethylene chain may have these polyoxyalkylene chains alone or may be copolymers that have been copolymerized with another polyoxyalkylene chain.

Examples of the polymerizable monomers denoted by general formula (B) described above in the case where the number s of repetitions of the unit is an integer of 3 or more and each of t and u is 0 include mono(meth)acrylic esters of polyalkylene glycols, e.g., polypropylene glycol, polybutylene glycol, and polytetramethylene glycol, and the above-described mono(meth)acrylic esters of polyalkylene glycols, in which an end that is not a mono(meth)acrylic ester has been terminated by an alkyl group having a carbon atom number of 1 to 6.

More specific examples of the polymerizable monomers denoted by general formula (B) include polypropylene glycol mono(meth)acrylates, polytetramethylene glycol (meth)acrylates, poly(ethylene glycol.propylene glycol) mono(meth)acrylates, polyethylene glycol.polypropylene glycol mono(meth)acrylates, poly(ethylene glycol.tetramethylene glycol) mono(meth)acrylates, polyethylene glycol.polytetramethylene glycol mono(meth)acrylates, poly(propylene glycol.tetramethylene glycol) mono(meth)acrylates, polypropylene glycol.polytetramethylene glycol mono(meth)acrylates, poly(propylene glycol.butylene glycol) mono(meth)acrylates, polypropylene glycol.polybutylene glycol mono(meth)acrylates, poly(ethylene glycol.butylene glycol) mono(meth)acrylates, polyethylene glycol.polybutylene glycol mono(meth)acrylates, poly(tetraethylene glycol.butylene glycol) mono(meth)acrylates, polytetraethylene glycol.polybutylene glycol mono(meth)acrylates, polybutylene glycol mono(meth)acrylates, poly(ethylene glycol.trimethylene glycol) mono(meth)acrylates, polyethylene glycol.polytrimethylene glycol mono(meth)acrylates, poly(propylene glycol.trimethylene glycol) mono(meth)acrylates, polypropylene glycol.polytrimethylene glycol mono(meth)acrylates, poly(trimethylene glycol.tetramethylene glycol) mono(meth)acrylates, polytrimethylene glycol.polytetramethylene glycol mono(meth)acrylates, poly(butylene glycol.trimethylene glycol) mono(meth)acrylates, and polybutylene glycol.polytrimethylene glycol mono(meth)acrylates.

These polymerizable monomers denoted by general formula (B) can be used alone, or at least two types can be used in combination. In this regard, “poly(ethylene glycol.propylene glycol)” refers to a random copolymer of ethylene glycol and propylene glycol, and “polyethylene glycol.polypropylene glycol” refers to a block copolymer of ethylene glycol and propylene glycol. The same goes for the others.

The solubility parameter (hereafter abbreviated as SP value) of the polymerizable monomer denoted by general formula (B) is 8.9 to 10.5 (cal/cm³)^{0.5}. In the case where the SP value is within the above-described range, the compatibility is ensured when a fluorosurfactant containing, as a component, the polymerizable monomer denoted by general formula (B) is added to the polymerizable compound, and uniform distribution in the coating film can be ensured. In particular, the SP value of the polymerizable monomer denoted by general formula (B) is more preferably within the range of 9.0 to 10.4 (cal/cm³)^{0.5} and particularly preferably within the range of 9.1 to 10.3 (cal/cm³)^{0.5} for the same reason as that described above.

In this regard, the SP value (solubility parameter/unit: ((cal/cm³)^{0.5}) in the present invention is calculated by Fedors method.

Meanwhile, the polymerizable monomer denoted by general formula (B) satisfies formula (1) described below. As a result, the compatibility is ensured when the fluorosurfactant containing, as a component, the polymerizable monomer denoted by general formula (B) is added to the polymerizable compound, and uniform distribution in the coating film can be ensured.

1.00<100×(s+t+u)/MB<2.10 (1)

(s represents an integer of 1 or more, each of t and u represents an integer of 0 or more, and MB represents the molecular weight of the polymerizable monomer denoted by general formula (B)) In particular, regarding the polymerizable monomer denoted by formula (1), a range of 1.10 to 2.10 is more preferable and a range of 1.20 to 2.10 is particularly preferable for the same reason as that described above.

(Polymerizable Monomer Containing Fluorine Atom)

Regarding the polymerizable monomer containing a fluorine atom, polymerizable monomers having an alkyl group or an alkylene ether group that contains a fluorine atom in an ester site of an acrylic acid ester or a methacrylic acid ester are used.

In particular, polymerizable monomer (A) that has a fluoroalkyl group having a carbon atom number of 4 to 6 (where the alkyl group includes an alkyl group having an ether bond due to an oxygen atom) is preferable.

(Polymerizable Monomer (A))

Examples of polymerizable monomer (A) include those denoted by general formula (A1) described below.

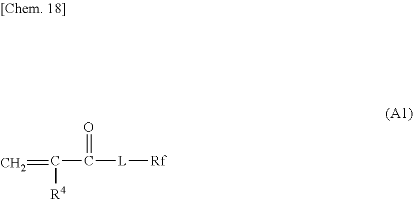

(in general formula (A1) described above, R⁴ represents a hydrogen atom, a fluorine atom, a methyl group, a cyano group, a phenyl group, a benzyl group, or —CₙH₂ₙ—Rf′ (n represents an integer of 1 to 8 and Rf′ represents any one of groups denoted by formulae (Rf-1) to (Rf-7) described below), L represents any one of groups denoted by formulae (L-1) to (L-10) described below, and Rf represents any one of groups denoted by formulae (Rf-1) to (Rf-7) described below)

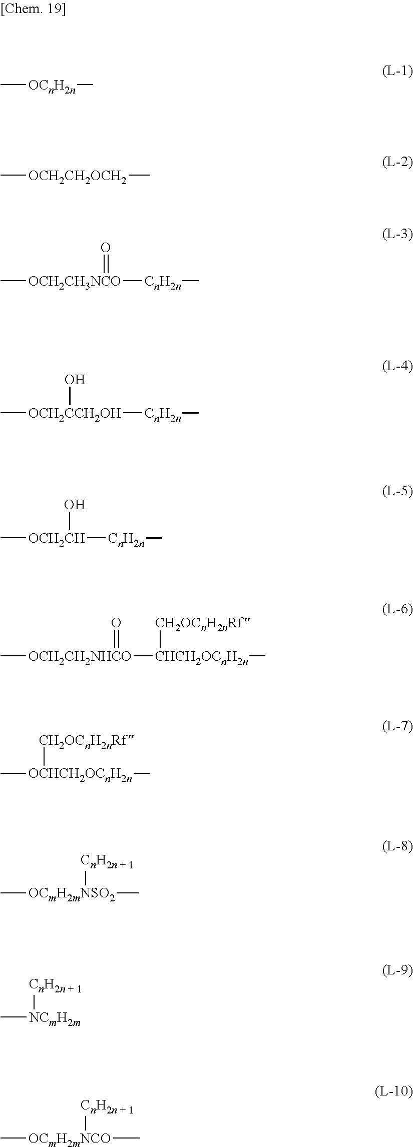

(in formulae (L-1), (L-3), (L-5), (L-6), and (L-7) described above, n represents an integer of 1 to 8, in formulae (L-8), (L-9), and (L-10) described above, m represents an integer of 1 to 8 and n represents an integer of 0 to 8, and in formulae (L-6) and (L-7) described above, Rf″ represents any one of groups denoted by formulae (Rf-1) to (Rf-7) described below)

[Chem. 20]

—CₙF₂ₙ₊₁ (Rf-1)

—CₙF₂ₙH (Rf-2)

—CₙF₂ₙ₋₁ (Rf-3)

—CₙF₂ₙ₋₃ (Rf-4)

—CₘF₂ₘOCₙF₂ₙCF₃ (Rf-5)

—CₘF₂ₘOCₙF₂ₙOCₚF₂ₚCF₃ (Rf-6)

—CF₂OC₂F₄OC₂F₄OCF₃ (Rf-7)

(in formulae (Rf-1) to (Rf-4) described above, n represents an integer of 4 to 6, in formula (Rf-5) described above, m represents an integer of 1 to 5, n represents an integer of 0 to 4, and the total of m and n is 4 to 5, and in formula (Rf-6) described above, m represents an integer of 0 to 4, n represents an integer of 1 to 4, p represents an integer of 0 to 4, and the total of m, n, and p is 4 to 5)

Also, more preferable examples of polymerizable monomer (A) described above include polymerizable monomers (A-1) to (A-15) described below. In this regard, these polymerizable monomers (A) can be used alone, or at least two types can be used in combination.

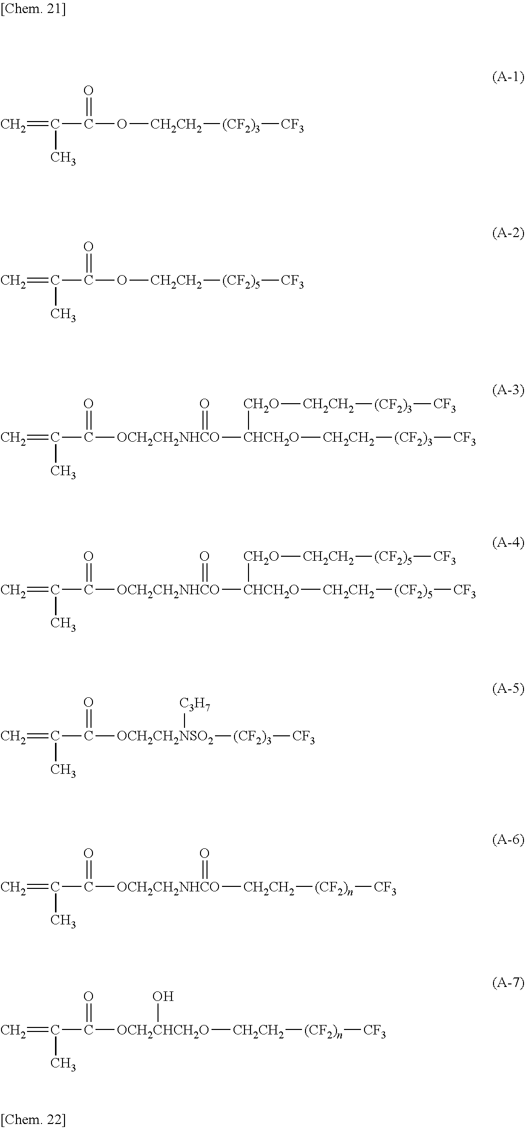

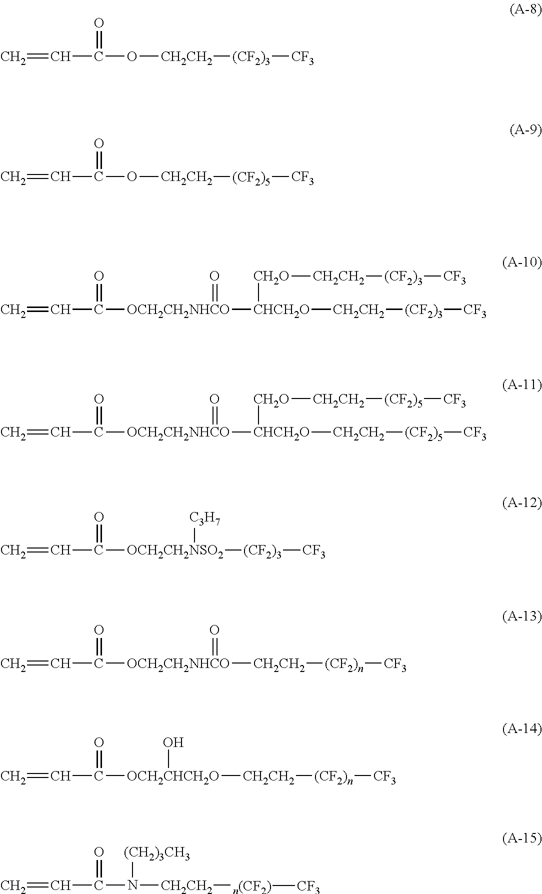

(Polymerizable Monomer (D))

In addition, regarding the polymerizable monomer containing a fluorine atom, polymerizable monomer (D) that has a poly(perfluoroalkylene ether) chain and polymerizable unsaturated groups at both ends thereof is preferable.

Regarding the polymerizable monomer (D), a polymerizable monomer having a structure in which divalent fluorocarbon groups having a carbon atom number of 1 to 3 and oxygen atoms are alternately coupled is used. The divalent fluorocarbon groups having a carbon atom number of 1 to 3 may be one type or be a mixture of a plurality of types and, specifically, are those denoted by structural formula (a1) described below.

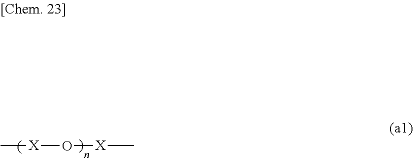

(in structural formula (a1) described above, X represents one of structural formulae (a1-1) to (a1-5), each X in the structural formula (a1) may be the same or be different from each other, a plurality of equal structures may be present at random or on a block basis, and n represents an integer of 1 or more that is the number of repetitions of the unit)

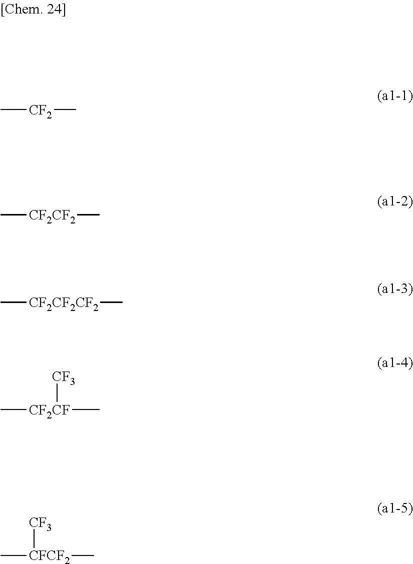

In particular, those in which a perfluoromethylene structure denoted by structural formula (a1-1) described above and a perfluoroethylene structure denoted by structural formula (a1-2) described above are present in combination are particularly preferable because the leveling properties of a coating composition including the fluorosurfactant according to the present invention is improved and a smooth coating film is produced. Here, regarding the ratio of presence of the perfluoromethylene structure denoted by structural formula (a1-1) to the perfluoroethylene structure denoted by structural formula (a1-2), the ratio that makes the molar ratio [structure (a1-1)/structure (a1-2)] 1/10 to 10/1 is preferable from the viewpoint of the leveling properties, the ratio that makes the molar ratio 2/8 to 8/2 is further preferable, and the ratio that makes the molar ratio 3/7 to 7/3 is particularly preferable. In this regard, the value of n in structural formula (a1) is preferably within the range of 3 to 100 and particularly preferably within the range of 6 to 70.

Meanwhile, regarding the poly(perfluoroalkylene ether) chain, the total of fluorine atoms included in one poly(perfluoroalkylene ether) chain is preferably within the range of 18 to 200 and more preferably within the range of 25 to 150 because the compatibility between the leveling properties of the coating composition and the solubility into a non-fluorine-based material in the coating composition can be ensured.

Regarding a compound, which is a raw material of polymerizable monomer (D) and which is in the state before being provided with polymerizable unsaturated groups at both ends thereof, compounds denoted by general formulae (a2-1) to (a2-6) described below are used. In this regard, “—PFPE-” in each of the structural formulae described below represents the poly(perfluoroalkylene ether) chain described above.

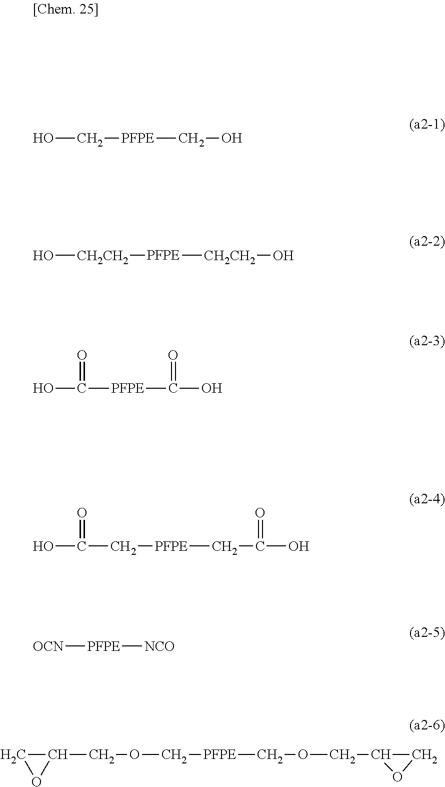

The polymerizable unsaturated groups present at both ends of the poly(perfluoroalkylene ether) chain of polymerizable monomer (D) include polymerizable unsaturated groups denoted by, for example, structural formulae U-1 to U-5 described below.

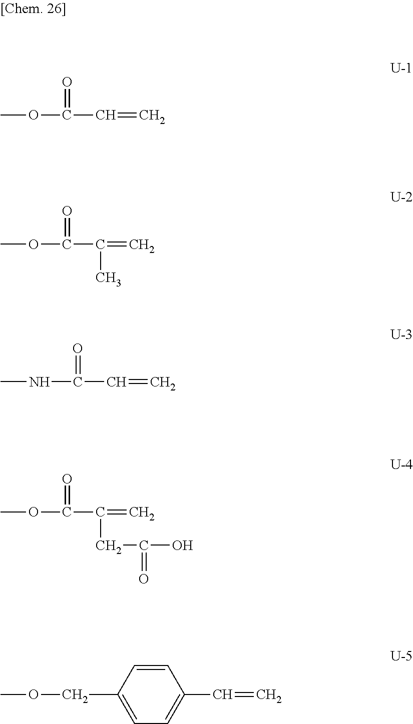

Among these polymerizable unsaturated groups, an acryloyloxy group denoted by structural formula U-1 or a methacryloyloxy group denoted by structural formula U-2 is particularly preferable because of availability and ease of production of polymerizable monomer (D) itself or ease of copolymerization with polymerizable monomer (B).

In this regard, in the present invention, “(meth)acryloyl group” refers to one of or both the methacryloyl group and the acryloyl group, “(meth)acrylate” refers to one of or both the methacrylate and the acrylate, and “(meth)acrylic acid” refers to one of or both the methacrylic acid and the acrylic acid.

Specific examples of polymerizable monomer (D) include polymerizable monomers denoted by structural formulae (D-1) to (D-13) described below. In this regard, “—PFPE-” in each of the structural formulae described below represents a poly(perfluoroalkylene ether) chain.

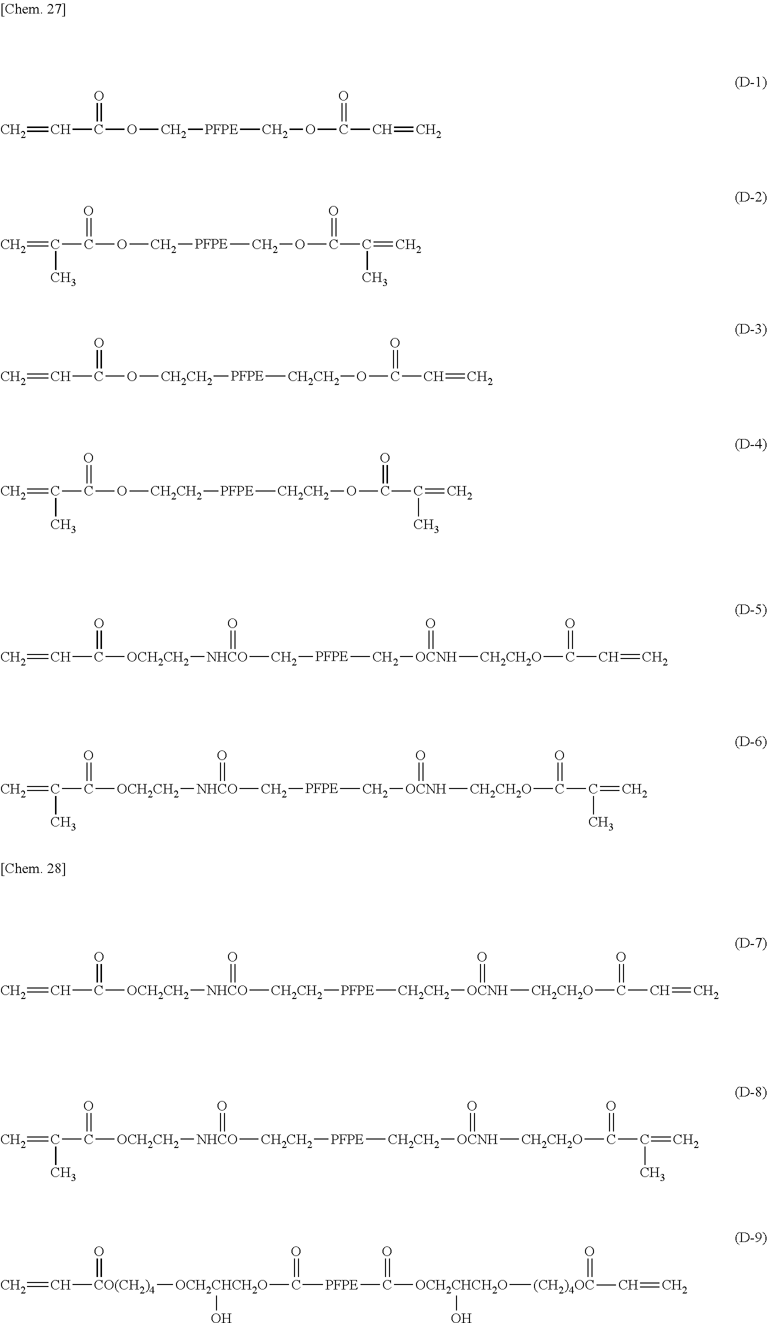

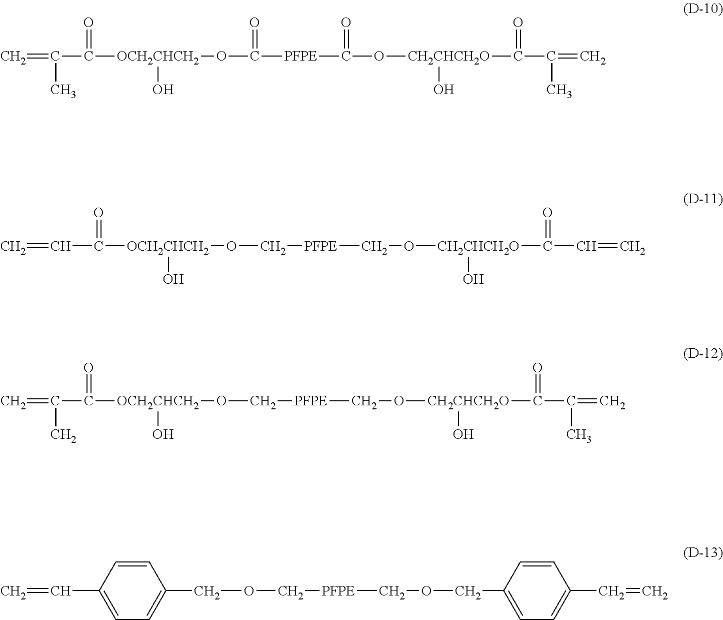

Among these polymerizable monomers (D), polymerizable monomers denoted by structural formulae (D-1), (D-2), (D-5), and (D-6) are preferable because of ease of industrial production of polymerizable monomer (D). The polymerizable monomer that is denoted by structural formula (D-1) and that has acryloyl groups at both ends of a poly(perfluoroalkylene ether) chain or the polymerizable monomer that is denoted by structural formula (D-2) and that has methacryloyl groups at both ends of a poly(perfluoroalkylene ether) chain is more preferable because the performance as the leveling agent can be further improved.

In order to ensure good leveling performance of the fluorosurfactant according to the present invention, the mass ratio [(X)/(B)] of the polymerizable monomer, which is a raw material for the fluorosurfactant, containing a fluorine atom to the polymerizable monomer denoted by general formula (B) is preferably within the range of 10/90 to 75/25, more preferably within the range of 15/85 to 70/30, and further preferably within the range of 20/80 to 65/35. Meanwhile, in order to reduce the transferability of the fluorosurfactant according to the present invention, the mass ratio [(X)/(B)] of the polymerizable monomer, which is a raw material for the fluorosurfactant, containing a fluorine atom to the polymerizable monomer denoted by general formula (B) is preferably within the range of 10/90 to 75/25, more preferably within the range of 15/85 to 70/30, and further preferably within the range of 20/80 to 65/35. In this regard, in the case where a polymerizable monomer other than the polymerizable monomer containing a fluorine atom and the polymerizable monomer denoted by general formula (B) is used, the content is preferably set to be 50 percent by mass or less in the total polymerizable monomer.

(Other Polymerizable Monomers)

The polymerizable monomer containing a fluorine atom and the polymerizable monomer denoted by general formula (B) are indispensable components of the raw material for copolymer (III) and, as another polymerizable monomer, polymerizable monomer (C) containing an alkyl group can be used in combination. Examples of polymerizable monomer (C) include polymerizable monomer denoted by general formula (C-1) described below.

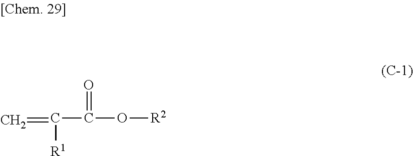

(in the formula, R¹ represents a hydrogen atom or a methyl group, and R² represents an alkyl group having a carbon atom number of 1 to 18 and having a straight-chain, branched, or ring-shaped structure)

In this regard, R² in general formula (C-1) described above is an alkyl group having a carbon atom number of 1 to 18 and having a straight-chain, branched, or ring-shaped structure, and this alkyl group may include a substituent, e.g., an aliphatic or aromatic hydrocarbon group and a hydroxy group. Specific examples of ethylenic unsaturated monomers having the alkyl group include alkyl esters having a carbon atom number of 1 to 18 of (meth)acrylic acid, e.g., methyl (meth)acrylate, ethyl (meth)acrylate, propyl (meth)acrylate, butyl (meth)acrylate, octyl (meth)acrylate, 2-ethylhexyl (meth)acrylate, decyl (meth)acrylate, dodecyl (meth)acrylate, and stearyl (meth)acrylate; and cross-linked cyclic alkyl esters having a carbon atom number of 1 to 18 of (meth)acrylic acid, e.g., dicyclopentanyloxylethyl (meth)acrylate, isobornyloxylethyl (meth)acrylate, isobornyl (meth)acrylate, adamantyl (meth)acrylate, dimethyladamantyl (meth)acrylate, dicyclopentanyl (meth)acrylate, and dicyclopentenyl (meth)acrylate. These polymerizable monomers (C) can be used alone, or at least two types can be used in combination.

Further, regarding the raw material for the fluorosurfactant according to the present invention, examples of polymerizable monomers that can be used in addition to the polymerizable monomer containing a fluorine atom, the polymerizable monomer denoted by general formula (B), and polymerizable monomer (C) include aromatic vinyls, e.g., styrene, α-methylstyrene, p-methylstyrene, and p-methoxystyrene; and maleimides, e.g., maleimide, methylmaleimide, ethylmaleimide, propylmaleimide, butylmaleimide, hexylmaleimide, octylmaleimide, dodecylmaleimide, stearylmaleimide, phenylmaleimide, and cyclohexylmaleimide.

Further, for example, aromatic vinyls, e.g., styrene, α-methylstyrene, p-methylstyrene, and p-methoxystyrene; and maleimides, e.g., maleimide, methylmaleimide, ethylmaleimide, propylmaleimide, butylmaleimide, hexylmaleimide, octylmaleimide, dodecylmaleimide, stearylmaleimide, phenylmaleimide, and cyclohexylmaleimide can be used. Further, polymerizable monomers that have a fluoroalkyl group having a carbon atom number of 1 to 6 may be used.

(Copolymer (III))

The fluorosurfactant used in the present invention is selected from the group consisting of copolymers (III), each of which is a copolymer produced by copolymerizing the polymerizable monomer denoted by general formula (B) and the polymerizable monomer containing a fluorine atom that are indispensable monomers. The weight average molecular weight (Mw) of the copolymer (III) is 2,500 to 35,000, preferably 2,500 to 33,000, and further preferably 2,500 to 30,000. If a copolymer having a weight average molecular weight of less than 2,500 is used, in the case where a base material is coated with a polymerizable liquid crystal composition containing the compound so as to produce an optically anisotropic body, great effect of improving the surface smoothness (cissing resistance) is not exerted. Meanwhile, if a copolymer having a weight average molecular weight of more than 35,000 is used, the compatibility with the polymerizable liquid crystal composition is degraded and, as a result, the surface smoothness may be adversely affected. If a copolymer having a weight average molecular weight of less than 2,500 is used, in the case where a base material is coated with a polymerizable liquid crystal composition containing the compound so as to produce an optically anisotropic body, the molecular weight is small and, as a result, a surfactant component significantly transfers from the coated surface to the base material when the base material is rolled up. Meanwhile, if a copolymer having a weight average molecular weight of more than 35,000 is used, the compatibility with the polymerizable liquid crystal composition is degraded so as to cause localization on the coating film surface and, as a result, transfer from the coating film surface to the base material may occur. Further, the molecular weight distribution (Mw/Mn) represented by the ratio of the weight average molecular weight (Mw) to the number average molecular weight (Mn) is preferably 1.05 to 5.00. Here, the weight average molecular weight (Mw) and the number average molecular weight (Mn) are values, in terms of polystyrene, based on GPC (gel permeation chromatography) measurement. In this regard, the measurement conditions for GPC are as described below.

[GPC Measurement Condition]

Measuring apparatus: “HLC-8220 GPC” produced by Tosoh Corporation, column: Guard column “HHR-H” (6.0 mm I. D.×4 cm) produced by Tosoh Corporation+“TSK-GEL GMHHR-N” (7.8 mm I. D.×30 cm) produced by Tosoh Corporation+“TSK-GEL GMHHR-N” (7.8 mm I. D.×30 cm) produced by Tosoh Corporation+“TSK-GEL GMHHR-N” (7.8 mm I. D.×30 cm) produced by Tosoh Corporation+“TSK-GEL GMHHR-N” (7.8 mm I. D.×30 cm) produced by Tosoh Corporation Measurement condition: column temperature of 40° C., developing solvent: tetrahydrofuran (THF), flow rate of 1.0 ml/min
Sample: 1.0-percent-by-mass, in terms of resin solid content, tetrahydrofuran solution that has been filtrated with a microfilter (5 μl)
Standard sample: the following monodisperse polystyrenes having known molecular weights were used in conformity with the measurement manual of the “GPC-8020 Model II Data Analysis Version 4.30”

### [Monodisperse Polystyrene]

“A-500” produced by Tosoh Corporation, “A-1000” produced by Tosoh Corporation, and “A-2500” produced by Tosoh Corporation
“A-5000” produced by Tosoh Corporation, “F-1” produced by Tosoh Corporation, and “F-2” produced by Tosoh Corporation “F-4” produced by Tosoh Corporation, “F-10” produced by Tosoh Corporation, and “F-20” produced by Tosoh Corporation “F-40” produced by Tosoh Corporation, “F-80” produced by Tosoh Corporation, and “F-128” produced by Tosoh Corporation “F-288” produced by Tosoh Corporation and “F-550” produced by Tosoh Corporation

The amount of the fluorosurfactant added is preferably 0.005 to 5 percent by mass relative to the total amount of the polymerizable compound and chiral compound, more preferably 0.01 to 3 percent by mass, and further preferably 0.05 to 2.0 percent by mass. In this regard, it is preferable that the amount of the fluorosurfactant added be appropriately adjusted in consideration of the molecular weight of the fluorosurfactant to be included. In general, in the case where a fluorosurfactant having a small molecular weight is used, it is desirable that the amount of addition be larger than the case where a fluorosurfactant having a large molecular weight is used. In the case where the fluorosurfactant having a weight average molecular weight (Mw) of 2,500 to 30,000 is used, the above-described range is preferable.

The copolymer (III) preferably has an oxyalkylene group denoted by —(XO)ₛ— (X represents an alkylene group having a carbon atom number of 1 to 10 and s represents an integer of 1 or more). Regarding the oxyalkylene group, an oxyethylene group, an oxyplopylene group, an oxybutylene group, and an oxytetramethylene group are preferable.

Also, the fluorosurfactant (III) may have a fluoroalkyl group, a fluoroalkenyl group and/or a fluoroalkylene ether group. The fluoroalkyl group, the fluoroalkenyl group, and/or the fluoroalkylene ether group can be a fluoroalkyl group, fluoroalkenyl group, and/or fluoroalkylene ether group, each of which is partly fluorinated or completely fluorinated and each of which is a straight or branched chain having a carbon atom number of about 3 to 12.

(Other Liquid Crystal Compounds)

Liquid crystal compounds not having a polymerizable group may be added to the polymerizable liquid crystal composition according to the present invention as necessary. However, if the amount of addition is excessive, the liquid crystal compounds may ooze from the resulting optically anisotropic body and, as a result, a multilayer member may be polluted. In addition, the heat resistance of the optically anisotropic body may be degraded. Therefore, in the case where the addition is performed, the amount of addition is set to be preferably 30 percent by mass or less relative to the total amount of the polymerizable liquid crystal compound, further preferably 15 percent by mass or less, and particularly preferably 5 percent by mass or less.

(Polymerization Initiator)

The polymerizable liquid crystal composition according to the present invention preferably contains at least one polymerization initiator, e.g., a thermal polymerization initiator and a photopolymerization initiator. Examples of thermal polymerization initiators include benzoyl peroxide and 2,2′-azobisisobutyronitrile. Also, examples of photopolymerization initiators include benzoin ethers, benzophenones, acetophenones, benzyl ketals, and thioxanthones. Specific examples include “Irgacure 651”, “Irgacure 184”, “Irgacure 907”, “Irgacure 127”, “Irgacure 369”, “Irgacure 379”, “Irgacure 819”, “Irgacure OXE01”, “Irgacure OXE02”, “Lucirin TPO”, and “Darocur 1173” by BASF and “Esacure 1001M”, “Esacure KIP150”, “Speedcure BEM”, “Speedcure BMS”, “Speedcure PBZ”, and “Benzophenone” by LAMBSON. Further, a photoacid generator can be used as a photo cationic initiator. Regarding the photoacid generator, preferably, a diazosulfone-based compound, a triphenylsulfonium-based compound, a phenylsulphone-based compound, a sulfonylpirydine-based compound, a triazine-based compound, and a diphenyliodonium compound are used.

The amount of the photopolymerization initiator used is preferably 0.1 to 10 percent by mass relative to the polymerizable liquid crystal composition, and particularly preferably 0.5 to 5 percent by mass. These can be used alone, or at least two types can be used in combination. Also, a sensitizing agent and the like may be added.

The polymerizable liquid crystal composition according to the present invention can include a compound that has a polymerizable group but is not a polymerizable liquid crystal compound. There is no particular limitation regarding use of such a compound as long as the compound is usually recognized to be a polymerizable monomer or a polymerizable oligomer in the related art. In the case where addition is performed, the amount is preferably 15 percent by mass or less relative to the total amount of the polymerizable compound and chiral compound used for the polymerizable liquid crystal composition according to the present invention, and further preferably 10 percent by mass or less.

(Other Compounds)

The polymerizable liquid crystal composition according to the present invention may contain at least one compound having a repletion unit denoted by general formula (3) described below and having a weight average molecular weight of 100 or more for the purpose of effectively decreasing the tilt angle at the interface to the air when the polymerizable liquid crystal composition is made into an optically anisotropic body.

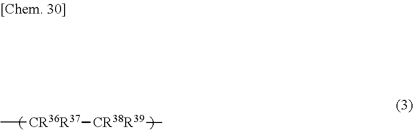

(in the formula, each of R³⁶, R³⁷, R³⁸, and R³⁹ represents a hydrogen atom, a halogen atom, or a hydrocarbon group having a carbon atom number of 1 to 20, and hydrogen atoms in the hydrocarbon group may be substituted with at least one halogen atom)

Examples of preferable compounds denoted by general formula (3) can include polyethylenes, polypropylenes, polyisobutylenes, paraffin, liquid paraffin, chlorinated polypropylenes, chlorinated paraffin, and chlorinated liquid paraffin.

The amount of the compound, which is denoted by general formula (3), added is preferably 0.01 to 1 percent by mass relative to the polymerizable liquid crystal composition, and more preferably 0.05 to 0.5 percent by mass.

(Chain Transfer Agent)

The polymerizable liquid crystal composition according to the present invention preferably includes a chain transfer agent for the purpose of further improving adhesion to the base material when the polymerizable liquid crystal composition is made into an optically anisotropic body. Regarding the chain transfer agent, thiol compounds are preferable, monothiol, dithiol, trithiol, tetrathiol compounds are more preferable, and trithiol compounds and tetrathiol compounds are further preferable. Specifically, compounds denoted by general formulae (4-1) to (4-12) described below are preferable.

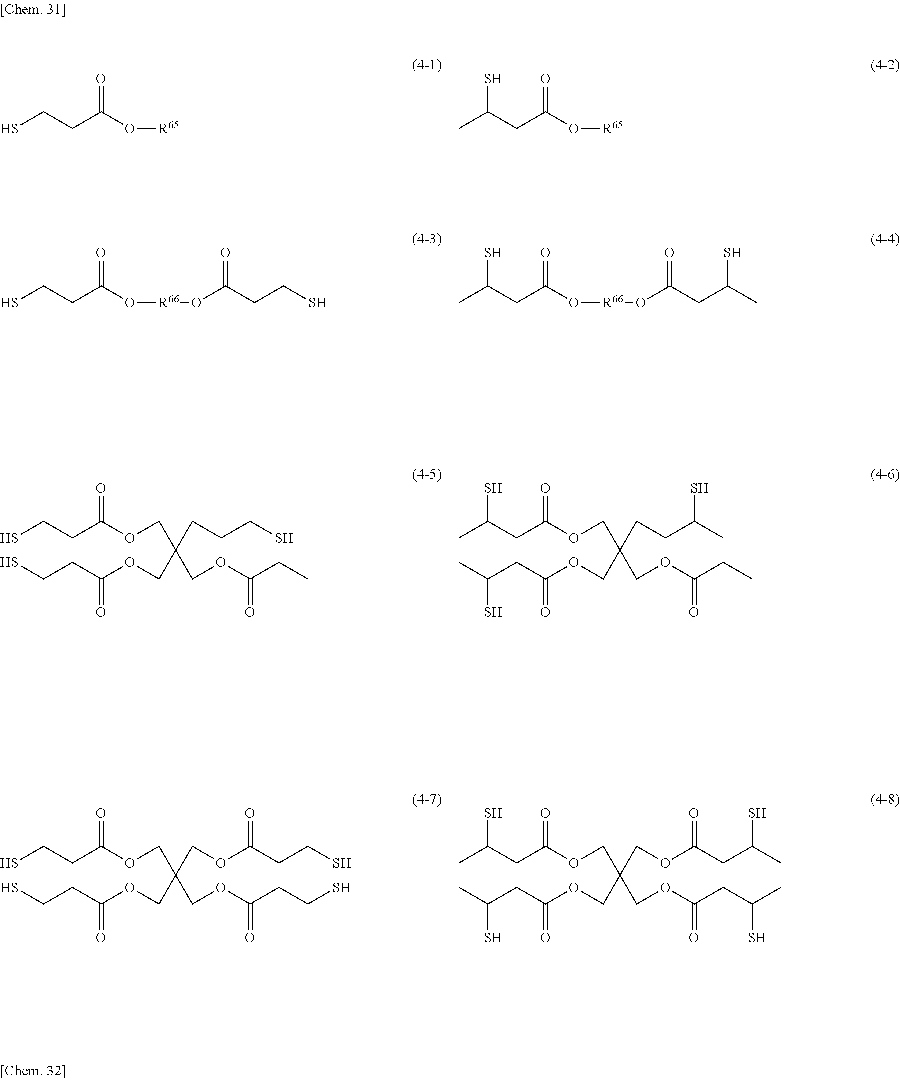

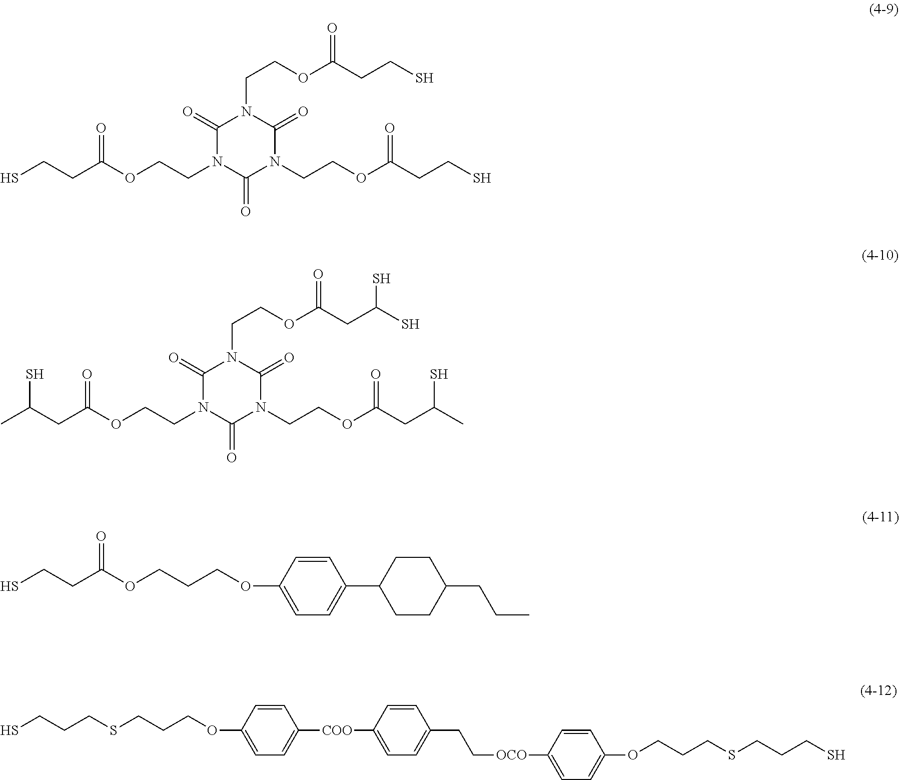

(in the formulae, R⁶⁵ represents an alkyl group having a carbon atom number of 2 to 18, the alkyl group may be a straight chain or a branched chain, at least one methylene group in the alkyl group may be substituted with an oxygen atom, a sulfur atom, —CO—, —OCO—, —COO—, or —CH═CH— as long as an oxygen atom and a sulfur atom do not directly bond to each other, R⁶⁶ represents an alkylene group having a carbon atom number of 2 to 18, and at least one methylene group in the alkylene group may be substituted with an oxygen atom, a sulfur atom, —CO—, —OCO—, —COO—, or —CH═CH— as long as an oxygen atom and a sulfur atom do not directly bond to each other)

The amount of the thiol compound added is preferably 0.5 to 10 percent by mass relative to the polymerizable composition, and more preferably 1.0 to 5.0 percent by mass.

(Other Additives)

Also, it is preferable that a polymerization inhibitor, an antioxidant, and the like be added for the purpose of enhancing the solution stability of the polymerizable liquid crystal composition according to the present invention. Examples of such compounds include hydroquinone derivatives, nitrosamine-based polymerization inhibitors, and hindered phenol-based antioxidants. More specific examples include p-methoxyphenol, tert-butylhydroquinone, methylhydroquinone, “Q-1300” and “Q-1301” by Wako Pure Chemical Industries, Ltd., and “IRGANOX 1010”, “IRGANOX 1035”, “IRGANOX 1076”, “IRGANOX 1098”, “IRGANOX 1135”, “IRGANOX 1330”, “IRGANOX 1425”, “IRGANOX 1520”, “IRGANOX 1726”, “IRGANOX 245”, “IRGANOX 259”, “IRGANOX 3114”, “IRGANOX 3790”, “IRGANOX 5057”, and “IRGANOX 565” by BASF.

The amount of the polymerization inhibitor and the antioxidant added is preferably 0.01 to 1.0 percent by mass relative to the polymerizable liquid crystal composition, and more preferably 0.05 to 0.5 percent by mass.

In the case where the polymerizable liquid crystal composition according to the present invention is used for applications such as raw materials for a polarization film and an alignment film, a printing ink, a paint, and a protective film, in accordance with the purpose, a metal, a metal complex, a dye, a pigment, a fluorescent material, a phosphorescent material, a thixotropic agent, a gelatinizer, polysaccharide, an ultraviolet absorber, an infrared absorber, an antioxidant, an ion-exchange resin, and a metal oxide, e.g., titanium oxide, may be added.

(Organic Solvent)

There is no particular limitation regarding an organic solvent used for the polymerizable liquid crystal composition according to the present invention. A solvent, into which the polymerizable compound exhibits good solubility, is preferable, and a solvent that can be dried at a temperature of 100° C. or lower is preferable. Examples of such solvents include aromatic hydrocarbons, e.g., toluene, xylene, cumene, and mesitylene, ester-based solvents, e.g., methyl acetate, ethyl acetate, propyl acetate, and butyl acetate, ketone-based solvents, e.g., methyl ethyl ketone, methyl isobutyl ketone, cyclohexanone, and cyclopentanone, ether-based solvents, e.g., tetrahydrofuran, 1,2-dimethoxyethane, and anisole, amide-based solvents, e.g., N,N-dimethylformamide and N-methyl-2-pyrrolidone, propylene glycol monomethyl ether acetate, diethylene glycol monomethyl ether acetate, γ-butyrolactone, and chlorobenzene. These can be used alone, or at least two types can be used in combination. It is preferable that at least one of ketone-based solvents, ether-based solvents, ester-based solvents, and aromatic hydrocarbon-based solvents be used. In the case where two types are used in combination, it is preferable that any one of ketone-based solvents and ester-based solvents be used by mixing from the viewpoint of solution stability.

The polymerizable liquid crystal composition is usually used by coating in the present invention. Therefore, there is no particular limitation regarding the proportion of the organic solvent in the polymerizable liquid crystal composition as long as a coated state is not significantly impaired. The solid content of the polymerizable liquid crystal composition is preferably 10 to 60 percent by mass, and further preferably 20 to 50 percent by mass.

(Method for Manufacturing Optically Anisotropic Body)

(Optically Anisotropic Body)

The optically anisotropic body according to the present invention is produced by coating a base material, which has an alignment function, with the polymerizable liquid crystal composition according to the present invention, uniformly aligning liquid crystal molecules in the polymerizable liquid crystal composition while the nematic phase is maintained, and performing polymerization.

(Base Material)

There is no particular limitation regarding the base material used for the optically anisotropic body according to the present invention as long as the base material is commonly used for a liquid crystal device, a display, an optical member, and an optical film and the material has heat resistance so as to resist heating during drying after application of a polymerizable liquid crystal composition solution according to the present invention. Examples of such base materials include glass base materials, metal base materials, ceramic base materials, and organic materials, e.g., plastic base materials. In particular, in the case where the base material is an organic material, examples thereof include cellulose derivatives, polyolefins, polyesters, polyolefins, polycarbonates, polyacrylates, polyarylates, polyether sulfones, polyimides, polyphenylene sulfides, polyphenylene ethers, nylons, and polystyrenes. In particular, plastic base materials, e.g., polyesters, polystyrenes, polyolefins, cellulose derivatives, polyarylates, and polycarbonates, are preferable. The shape of the base material may be a flat shape and, in addition, may be a shape having a curved surface. These base materials may have an electrode layer, an antireflection function, or a reflection function, as necessary.

These base materials may be subjected to surface treatment for the purpose of enhancing the application properties and adhesive properties of the polymerizable liquid crystal composition solution according to the present invention. Examples of surface treatment include ozone treatment, plasma treatment, corona treatment, and silane coupling treatment. Meanwhile, in order to adjust the transmittance and the reflectance of the light, an organic thin film, an inorganic oxide thin film, a metal thin film, or the like may be disposed by evaporation or the like on the base material surface. Alternatively, in order to provide an optical added value, the base material may be a pickup lens, a rod lens, an optical disc, a phase difference film, a light diffusion film, a color filter, and the like. In particular, a pickup lens, a phase difference film, a light diffusion film, and a color filter are preferable because the added value further increases.

(Alignment Treatment)

The above-described base material may be subjected to common alignment treatment or be provided with an alignment film such that the polymerizable composition is aligned when the polymerizable liquid crystal composition solution according to the present invention is applied and dried. Examples of alignment treatment include stretching treatment, rubbing treatment, polarized ultraviolet-visible light irradiation treatment, ion beam treatment, and SiO₂ oblique evaporation treatment of the base material. In the case where the alignment film is used, a known common alignment film is used. Examples of such alignment films include compounds, e.g., a polyimide, a polysiloxane, a polyamide, a polyvinyl alcohol, a polycarbonate, a polystyrene, a polyphenylene ether, a polyarylate, a polyethylene terephthalate, a polyether sulfone, an epoxy resin, an epoxy acrylate resin, an acrylic resin, a coumarin compound, a calcone compound, a cinnamate compound, a fulgide compound, an anthraquinone compound, an azo compound, and an arylethene compound. It is preferable that the compound to be subjected to the alignment treatment by rubbing be a compound in which crystallization of a material is facilitated by the alignment treatment or by performing a heating step after the alignment treatment. Regarding the compounds subjected to an alignment treatment other than rubbing, it is preferable that photo-alignment material be used.

In general, in the case where a liquid crystal composition comes into contact with a substrate having an alignment function, liquid crystal molecules are aligned in the vicinity of the substrate in the direction in which the substrate has been subjected to the alignment treatment. Whether liquid crystal molecules are aligned so as to become horizontal to the substrate or are aligned slantingly or vertically is influenced to a large extent by the alignment treatment method for the substrate. For example, in the case where an alignment film that has a very small tilt angle and that is used for an in-plane switching (IPS) liquid crystal display element is used, a substantially horizontally aligned polymerizable liquid crystal layer may be obtained.

Meanwhile, in the case where an alignment film that is used for a TN liquid crystal display element is disposed on the substrate, a polymerizable liquid crystal layer aligned slantingly to a small extent may be obtained. In the case where an alignment film that is used for an STN liquid crystal display element is disposed on the substrate, a polymerizable liquid crystal layer aligned slantingly to a large extent may be obtained.

When a liquid crystal composition comes into contact with a substrate that has a very small tilt angle and that has a horizontal alignment (substantially horizontal alignment) function, liquid crystal molecules in the composition are uniformly horizontally aligned in the vicinity of the substrate but, in the vicinity of the interface to the air, alignment is partly disturbed because an alignment regulation force is not smoothly propagated (this is an alignment defect). However, it is considered that the polymerizable liquid crystal composition containing copolymer (S), according to the present invention, can produce a uniformly aligned optically anisotropic body having no alignment defect and exhibiting high optical anisotropy because copolymer (S) is unevenly distributed in the vicinity of the interface to the air and aligns liquid crystal molecules in the vicinity of the interface to the air without hindering the alignment regulation force, which is applied to liquid crystal molecules in the polymerizable liquid crystal composition, on the substrate side.

(Coating)

Regarding the coating method for producing the optically anisotropic body according to the present invention, known common methods, e.g., an applicator method, a bar coating method, a spin coating method, a roll coating method, a direct gravure coating method, a reverse gravure coating method, a flexo coating method, an ink jet method, a die coating method, a cap coating method, a dip coating method, and a slit coating method, can be performed. After the polymerizable liquid crystal composition is applied, drying is performed.

It is preferable that, after the coating is performed, liquid crystal molecules in the polymerizable liquid crystal composition according to the present invention be uniformly aligned while a nematic phase is maintained. Specifically, it is preferable that heat treatment for facilitating alignment of the liquid crystal be performed because the copolymer (S) can be more unevenly distributed on the surface and alignment can be further facilitated. Regarding the heat treatment method, for example, the polymerizable liquid crystal composition according to the present invention is applied to a substrate and, thereafter, heating to an N (nematic phase)-I (isotropic liquid phase) transition temperature (hereafter abbreviated as transition temperature) of the liquid crystal composition or higher is performed so as to make the liquid crystal composition into an isotropic liquid state. Then, gradual cooling is performed, as necessary, so as to realize a nematic phase. At this time, it is desirable that a temperature, at which a liquid crystal phase is realized, be temporarily maintained and, thereby, a liquid crystal phase domain be sufficiently grown so as to form a monodomain. Alternatively, the polymerizable liquid crystal composition according to the present invention is applied to a substrate and, thereafter, heating treatment may be performed such that the temperature is maintained in a temperature range, in which a nematic phase of the polymerizable liquid crystal composition according to the present invention is realized, for a predetermined time.

If the heating temperature is excessively high, the polymerizable liquid crystal compound may be degraded because of an occurrence of unfavorable polymerization reaction. Meanwhile, if cooling is performed excessively, phase separation of the polymerizable liquid crystal composition may occur, crystals may be precipitated, a highly ordered liquid crystal phase such as a smectic phase may be realized, and alignment treatment may become impossible.

In the case where such heat treatment is performed, homogeneous optically anisotropic body having reduced alignment defects can be produced compared with the coating method in which only coating is performed.

In addition, in the case where, after uniform alignment treatment is performed as described above, cooling is performed to the lowest temperature, at which phase separation of the liquid crystal phase does not occur, that is, until a supercooled state is reached, and polymerization is performed while the liquid crystal phase is aligned at that temperature, an optically anisotropic body having higher alignment order and excellent transparency can be obtained.

(Polymerization Step)

In general, polymerization treatment of the dried polymerizable liquid crystal composition in the state of planar alignment is performed by light irradiation using ultraviolet rays or the like or heating. In the case where the polymerization is performed by light irradiation, specifically, it is preferable to radiate ultraviolet light with 390 nm or less, and it is most preferable to radiate the light with a wavelength of 250 to 370 nm. However, in the case where decomposition or the like of the polymerizable composition is caused due to ultraviolet light with 390 nm or less, it may be preferable to perform polymerization treatment by using ultraviolet light with 390 nm or more. Preferably, this light is diffused light and is unpolarized light.

(Polymerization Method)

Examples of methods for polymerizing the polymerizable liquid crystal composition according to the present invention include a method in which active energy rays are radiated and a thermal polymerization method. The method in which active energy rays are radiated is preferable because heating is not necessary and the reaction proceeds at room temperature. In particular, a method in which ultraviolet light or the like is radiated is preferable because of ease of operation. The temperature during irradiation is set to be a temperature at which the polymerizable liquid crystal composition according to the present invention can maintain a liquid crystal phase and is preferably 30° C. or lower as much as possible for the purpose of avoiding induction of thermal polymerization of the polymerizable liquid crystal composition. In this regard, a liquid crystal composition usually has a liquid crystal phase in the range of a C (solid phase)-N (nematic) transition temperature (hereafter abbreviated as C—N transition temperature) to an N—I transition temperature in the process of temperature increase. Meanwhile, in the process of temperature decrease, the liquid crystal composition is in a thermodynamically non-equilibrium state and, therefore, may maintain the liquid crystal state without solidifying even at the C—N transition temperature or lower. This state is referred to as a supercooled state. In the present invention, the liquid crystal composition in the supercooled state is included in the state in which the liquid crystal phase is maintained. Specifically, it is preferable to radiate ultraviolet light with 390 nm or less, and it is most preferable to radiate the light with a wavelength of 250 to 370 nm. However, in the case where decomposition or the like of the polymerizable composition is caused due to ultraviolet light with 390 nm or less, it may be preferable to perform polymerization treatment by using ultraviolet light with 390 nm or more. Preferably, this light is diffused light and is unpolarized light. The ultraviolet radiation intensity is preferably within the range of 0.05 kW/m² to 10 kW/m². In particular, the range of 0.2 kW/m² to 2 kW/m² is preferable. If the ultraviolet intensity is less than 0.05 kW/m², it takes much time until the polymerization is completed. On the other hand, if the intensity is more than 2 kW/m², liquid crystal molecules in the polymerizable liquid crystal composition tend to be photodecomposed and, in addition, much heat of polymerization is generated, the temperature increases during the polymerization, the order parameter of polymerizable liquid crystal is varied, and the retardation of the film after polymerization may become out of order.

An optically anisotropic body having a plurality of regions with alignment directions different from each other can also be obtained by polymerizing only a specific portion by radiating ultraviolet rays while a mask is used, changing the alignment state of the unpolymerized portion by applying an electric field, a magnetic field, a temperature, or the like and, thereafter, polymerizing the unpolymerized portion.

Also, optically anisotropic body having a plurality of regions with alignment directions different from each other can be obtained by regulating the alignment in advance by applying an electric field, a magnetic field, a temperature, or the like to the polymerizable liquid crystal composition in an unpolymerized state when only a specific portion is polymerized by radiating ultraviolet rays while a mask is used, and performing polymerization by radiating the light from above the mask while the above-described state is maintained.

The optically anisotropic body produced by polymerizing the polymerizable liquid crystal composition according to the present invention can be peeled from the substrate so as to be used alone as an optically anisotropic body or can be used as an optically anisotropic body on an “as is” basis without being peeled from the substrate. In particular, the resulting optically anisotropic body does not easily pollute another member and, therefore, is valuable for the use as a substrate, on which stacking is performed, or for the use by being bonded to another substrate.

### EXAMPLES

The present invention will be described below with reference to synthesis examples, examples, and comparative examples but the present invention is not limited to these, as a matter of course. In this regard, “part” and “%” are on a mass basis unless otherwise specified.

### Example 1

Polymerizable liquid crystal composition (1) of example 1 was obtained by agitating 30 parts of compound denoted by formula (A-1), 30 parts of compound denoted by formula (A-2), 15 parts of compound denoted by formula (B-1), 15 parts of compound denoted by formula (B-2), 10 parts of compound denoted by formula (B-3), 0.1 parts of compound (E-1), 5 parts of compound (F-1), 0.15 parts of compound denoted by formula (H-1) that was a surfactant, and 300 parts of compound (G-1) that was an organic solvent for 1 hour under the condition of an agitation rate of 500 rpm and a solution temperature of 80° C. by using an agitator with an agitating propeller and, thereafter, performing filtration with a 0.2-μm membrane filter.

### Examples 2 to 37 and Comparative Examples 1 to 6

In the same manner as preparation of polymerizable liquid crystal composition (1) according to the present invention, polymerizable liquid crystal compositions (2) to (33) of examples 2 to 33, polymerizable liquid crystal compositions (40) to (43) of examples 34 to 37, and polymerizable liquid crystal compositions (34) to (39) of comparative examples 1 to 6 were obtained by agitating compounds denoted by formula (A-1) to formula (A-10), formula (B-1) to formula (B-8), formula (C-1) and formula (C-2), compounds denoted by formula (D-1) and formula (D-2), compound (E-1), compound (F-1), compounds denoted by formula (H-1) to (H-17) that are shown in Table 1 to Table 4, and 300 parts of compound (G-1) that is an organic solvent for 1 hour under the condition of an agitation rate of 500 rpm and a solution temperature of 80° C. by using an agitator with an agitating propeller and, thereafter, performing filtration with a 0.2-μm membrane filter.

Table 1 to Table 4 show specific compositions of the polymerizable compositions (1) to (33) and (40) to (43) according to the present invention and polymerizable liquid crystal compositions (34) to (39) for comparisons. In addition, Table 5 shows the SP value and the value of formula (1) of the polymerizable monomer denoted by general formula (B) in each of the compounds denoted by formula (H-1) to formula (H-17), the weight average molecular weight (Mw) of each of the compounds denoted by formula (H-1) to formula (H-17), and the value of the mass ratio [(X)/(B)] of the polymerizable monomer (X) containing a fluorine atom to the polymerizable monomer denoted by general formula (B) in each of the compounds denoted by formula (H-1) to formula (H-17).

TABLE 1

| Polymerizable | | | | | | | | | | | | | |
|---|---|---|---|---|---|---|---|---|---|---|---|---|---|
| liquid crystal | | | | | | | | | | | | | |
| composition | (1) | (2) | (3) | (4) | (5) | (6) | (7) | (8) | (9) | (10) | (11) | (12) | (13) |
| (A-1) | 30 | 30 | 30 | 30 | 30 | 30 | 30 | 30 | 30 | 30 | 30 | 30 | 40 |
| (A-2) | 30 | 30 | 30 | 30 | 30 | 30 | 30 | 30 | 30 | 30 | 30 | 30 | 40 |
| (A-3) | | | | | | | | | | | | | 20 |
| (B-1) | 15 | 15 | 15 | 15 | 15 | 15 | 15 | 15 | 15 | 15 | 15 | 15 | |
| (B-2) | 15 | 15 | 15 | 15 | 15 | 15 | 15 | 15 | 15 | 15 | 15 | 15 | |
| (B-3) | 10 | 10 | 10 | 10 | 10 | 10 | 10 | 10 | 10 | 10 | 10 | 10 | |
| (E-1) | 0.1 | 0.1 | 0.1 | 0.1 | 0.1 | 0.1 | 0.1 | 0.1 | 0.1 | 0.1 | 0.1 | 0.1 | 0.1 |
| (F-1) | 5 | 5 | 5 | 5 | 5 | 5 | 5 | 5 | 5 | 5 | 5 | 5 | 5 |
| (G-1) | 300 | 300 | 300 | 300 | 300 | 300 | 300 | 300 | 300 | 300 | 300 | 300 | 300 |
| (H-1) | 0.15 | | | | | | | | | | | | 0.15 |
| (H-2) | | 0.15 | 0.20 | | | | | | | | | | |
| (H-3) | | | | 0.15 | | | | | | | | | |
| (H-4) | | | | | 0.10 | | | | | | | | |
| (H-5) | | | | | | 0.20 | | | | | | | |
| (H-6) | | | | | | | 0.10 | | | | | | |
| (H-7) | | | | | | | | 0.15 | | | | | |
| (H-8) | | | | | | | | | 0.15 | | | | |
| (H-9) | | | | | | | | | | 0.15 | | | |
| (H-10) | | | | | | | | | | | 0.15 | | |
| (H-11) | | | | | | | | | | | | 0.15 | |

TABLE 2

| Polymerizable | | | | | | | | | | | | | |
|---|---|---|---|---|---|---|---|---|---|---|---|---|---|
| liquid crystal | | | | | | | | | | | | | |
| composition | (14) | (15) | (16) | (17) | (18) | (19) | (20) | (21) | (22) | (23) | (24) | (25) | (26) |
| (A-1) | 40 | 40 | 40 | 40 | 40 | 10 | | | | | | | |
| (A-2) | 40 | 40 | 40 | 40 | 40 | 10 | 40 | | | | | | |
| (A-3) | 20 | 20 | 20 | 20 | 20 | | | | | | | | |
| (A-4) | | | | | | | 10 | | | | | | |
| (A-5) | | | | | | | 25 | 43 | 43 | 43 | 43 | 15 | 15 |
| (A-6) | | | | | | | 25 | 43 | 43 | 43 | 43 | 45 | 45 |
| (A-8) | | | | | | | | | | | | 40 | 40 |
| (B-1) | | | | | | 40 | | | | | | | |
| (B-2) | | | | | | 40 | | | | | | | |
| (B-3) | | | | | | | | 14 | 14 | 14 | 14 | | |
| (E-1) | 0.1 | 0.1 | 0.1 | 0.1 | 0.1 | 0.1 | 0.1 | 0.1 | 0.1 | 0.1 | 0.1 | 0.1 | 0.1 |
| (F-1) | 5 | 5 | 5 | 5 | 5 | 5 | 5 | 3 | 3 | 3 | 3 | 3 | 3 |
| (G-1) | 300 | 300 | 300 | 300 | 300 | 300 | 300 | 300 | 300 | 300 | 300 | 300 | 300 |
| (H-2) | 0.15 | | | | | 0.15 | 0.15 | 0.10 | 0.10 | | | 0.10 | 0.10 |
| (H-3) | | 0.15 | | | | | | | | | | | |
| (H-4) | | | 0.10 | | | | | | | | | | |
| (H-5) | | | | 0.20 | | | | | | 0.30 | 0.30 | | |
| (H-6) | | | | | 0.10 | | | | | | | | |

TABLE 3

| Polymerizable | | | | | | | | | | | | | |
|---|---|---|---|---|---|---|---|---|---|---|---|---|---|
| liquid crystal | | | | | | | | | | | | | |
| composition | (27) | (28) | (29) | (30) | (31) | (32) | (33) | (34) | (35) | (36) | (37) | (38) | (39) |
| (A-1) | | | 42 | 9 | | 20 | 35 | 30 | 30 | 30 | 30 | 30 | |
| (A-2) | 10 | | 33 | 4 | | | 35 | 30 | 30 | 30 | 30 | 30 | |
| (A-3) | 20 | 10 | | | 43 | 30 | | | | | | | |
| (A-5) | 27.5 | 27.5 | | | | | | | | | | | 43 |
| (A-6) | 27.5 | 27.5 | | | | | | | | | | | 43 |
| (A-7) | | | | | 34 | | | | | | | | |
| (A-9) | | | | 47 | | | | | | | | | |
| (B-1) | | 10 | | | | | | 15 | 15 | 15 | 15 | 15 | |
| (B-2) | | 10 | 25 | 25 | | | | 15 | 15 | 15 | 15 | 15 | |
| (B-3) | 15 | 15 | | | | | | 10 | 10 | 10 | 10 | 10 | 14 |
| (B-4) | | | | 15 | | | | | | | | | |
| (B-6) | | | | | 23 | | | | | | | | |
| (B-7) | | | | | | 30 | | | | | | | |
| (C-1) | | | | | | 20 | | | | | | | |
| (C-2) | | | | | | | 30 | | | | | | |
| (D-1) | | | 8 | | | | | | | | | | |
| (D-2) | | | | 5 | | | | | | | | | |
| (E-1) | 0.1 | 0.1 | 0.1 | 0.1 | 0.1 | 0.1 | 0.1 | 0.1 | 0.1 | 0.1 | 0.1 | 0.1 | 0.1 |
| (F-1) | 3 | 3 | 5 | 5 | 3 | 3 | 3 | 5 | 5 | 5 | 5 | 5 | 3 |
| (G-1) | 300 | 300 | 300 | 300 | 300 | 300 | 300 | 300 | 300 | 300 | 300 | 300 | 300 |
| (H-2) | 0.10 | 0.10 | 0.10 | 0.10 | 0.10 | 0.10 | 0.10 | | | | | | |
| (H-12) | | | | | | | | 0.15 | | | | | 0.10 |
| (H-13) | | | | | | | | | 0.15 | | | | |
| (H-14) | | | | | | | | | | 0.15 | | | |
| (H-15) | | | | | | | | | | | 0.15 | | |
| (H-16) | | | | | | | | | | | | 0.15 | |

TABLE 4

Polymerizable liquid crystal composition

| | (40) | (41) | (42) | (43) |
|---|---|---|---|---|
| (A-2) | | 15 | | |
| (A-3) | | 25 | | |
| (A-5) | 15 | | 50 | 20 |
| (A-6) | 45 | | 50 | 50 |
| (A-10) | 40 | | | |
| (B-1) | | 15 | | |
| (B-2) | | 45 | | |
| (B-8) | | | | 30 |
| (E-1) | 0.1 | 0.1 | 0.1 | 0.1 |
| (F-1) | 3 | 3 | 3 | 3 |
| (G-1) | 300 | 300 | 300 | 300 |
| (H-2) | 0.10 | | | |
| (H-5) | | | 0.05 | 0.05 |
| (H-17) | | 0.05 | | |

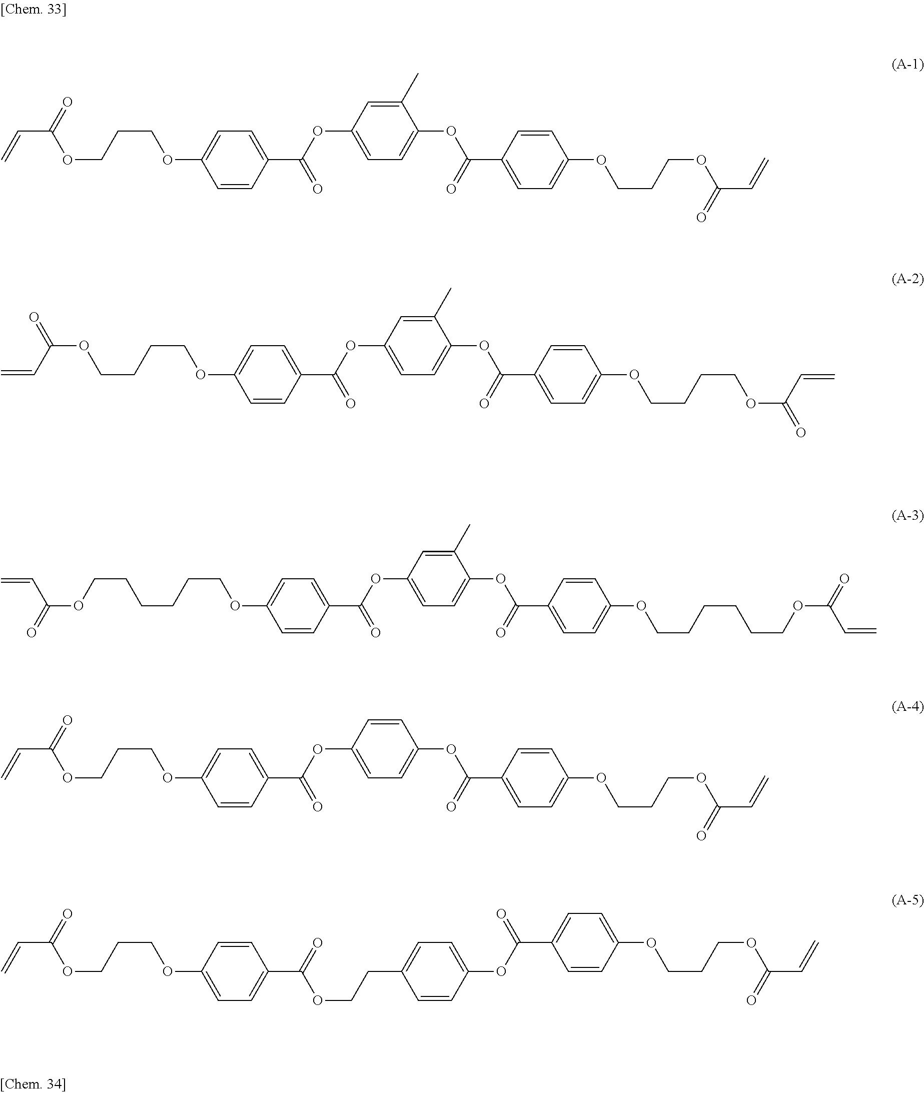

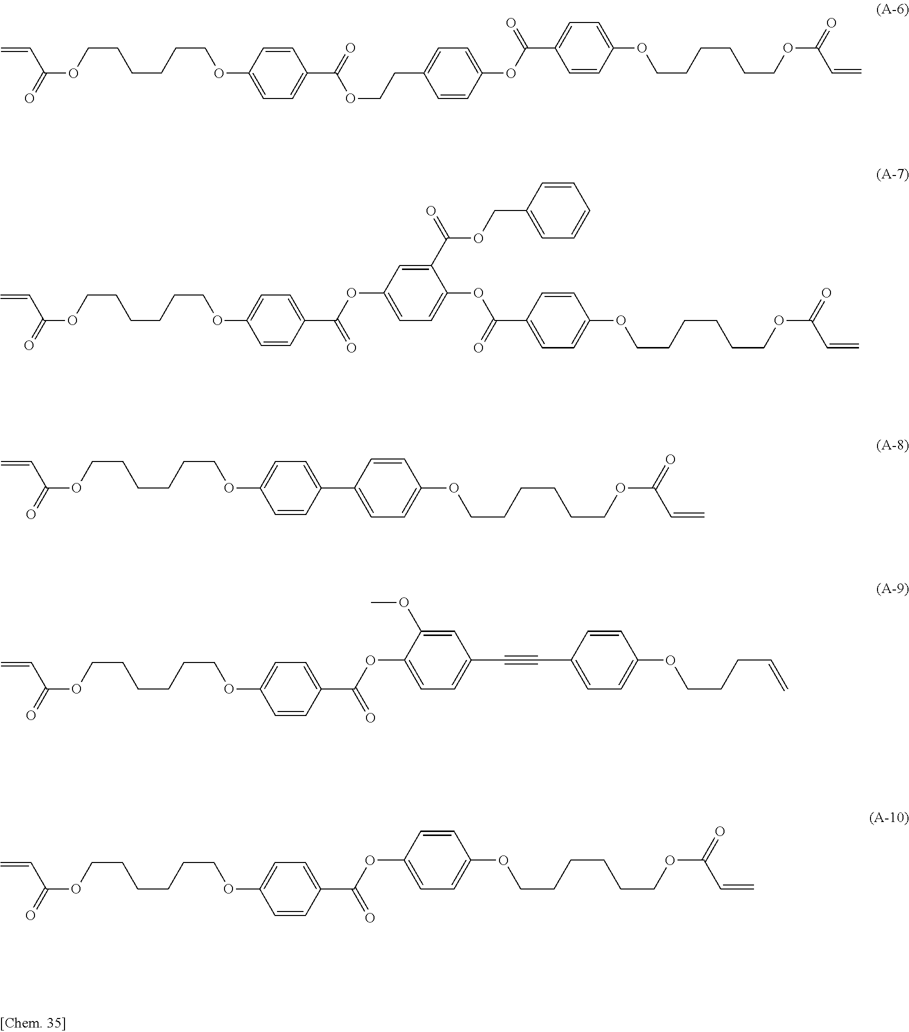

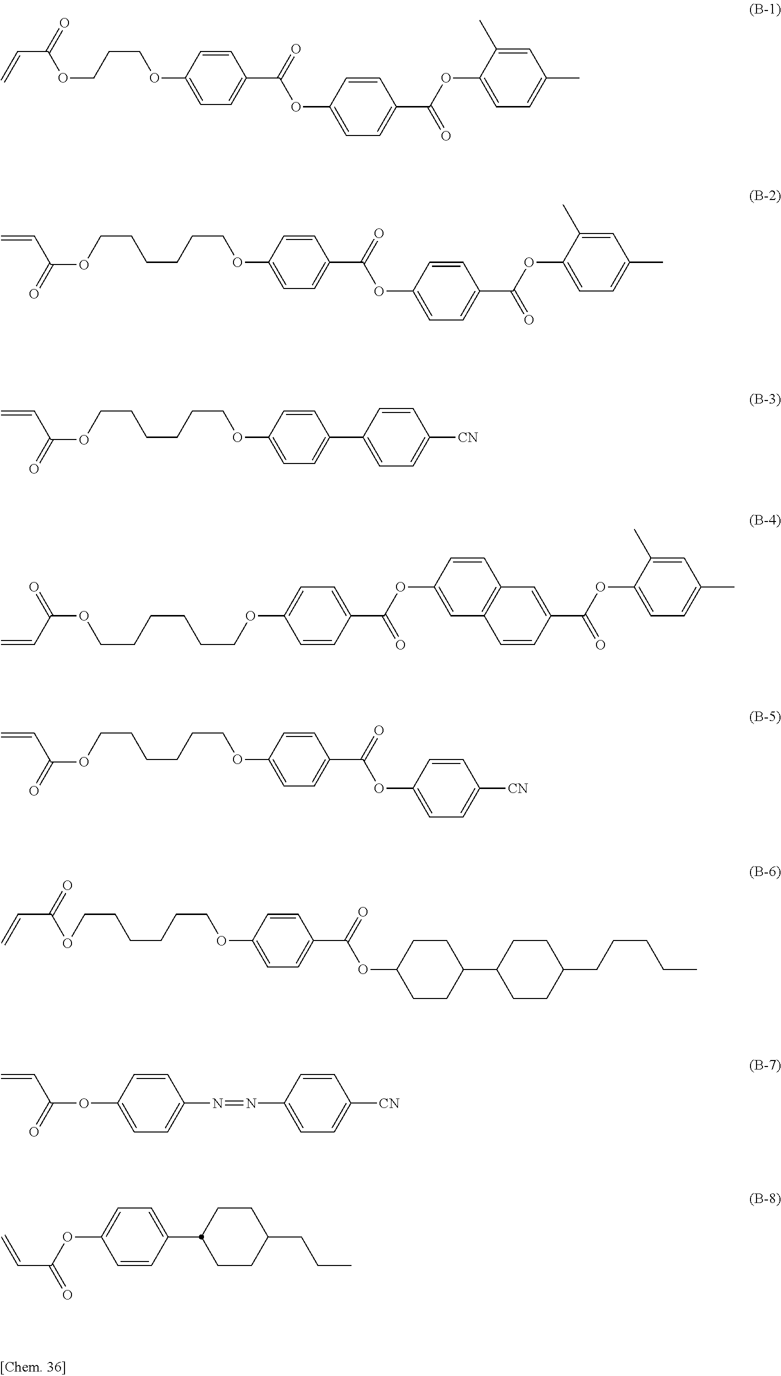

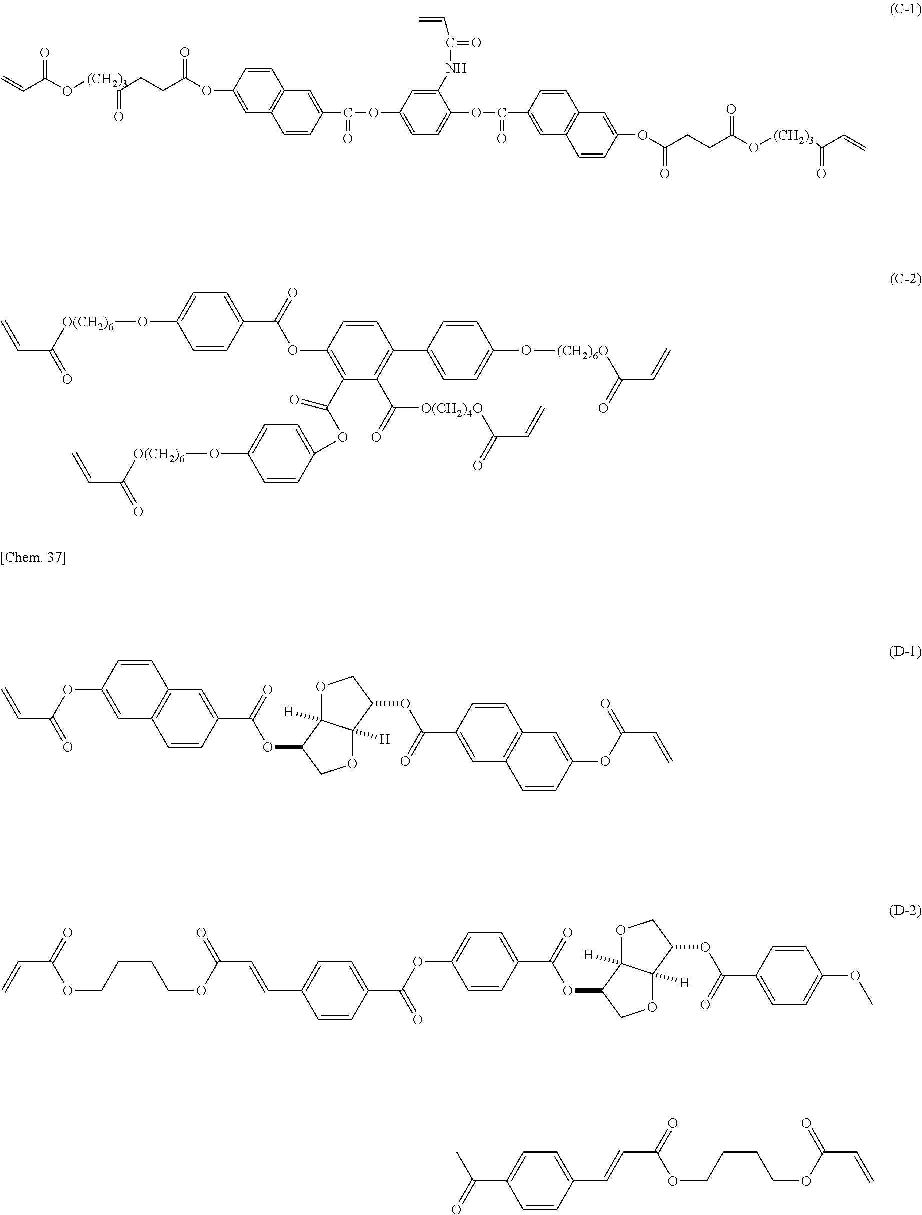

p-Methoxyphenol (E-1)

### Irgacure 907 (F-1)

Methyl isobutyl ketone (G-1)

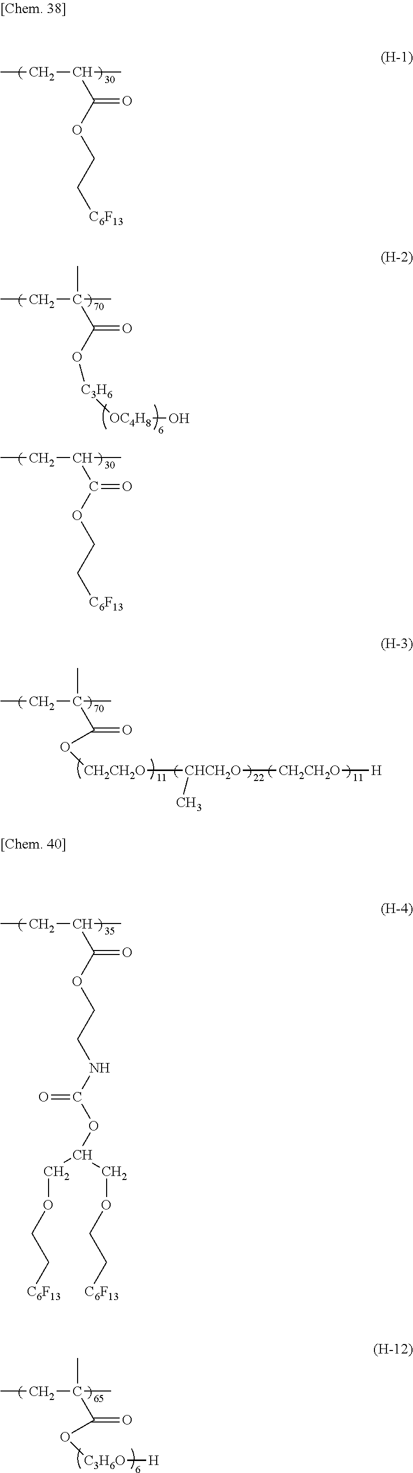

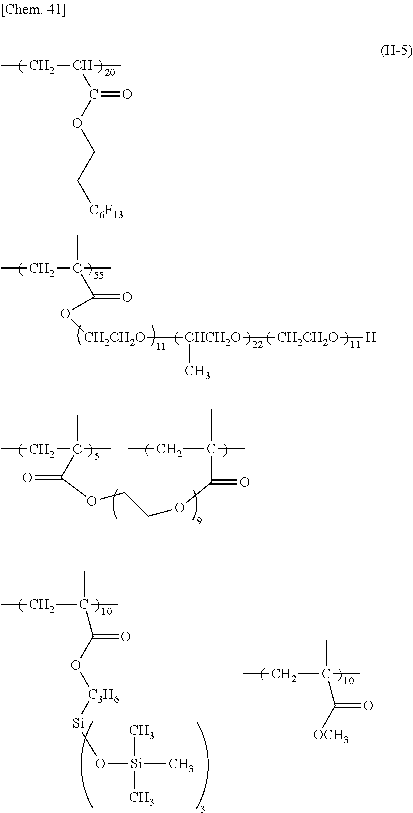

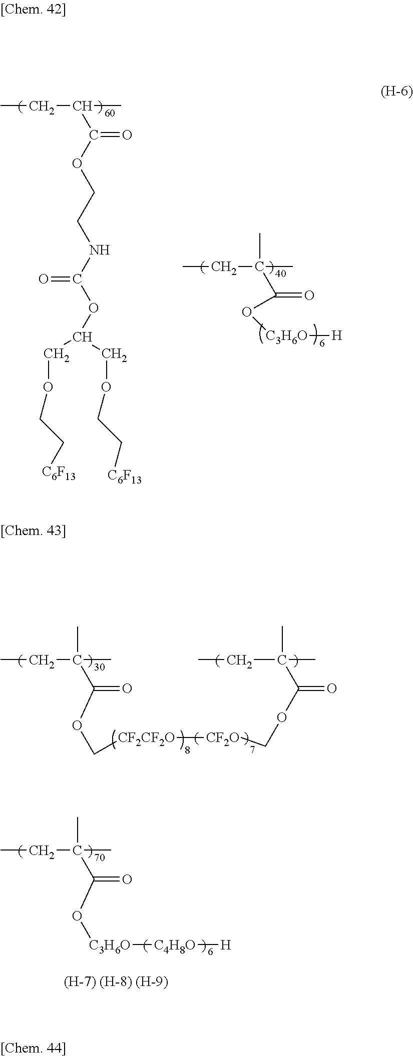

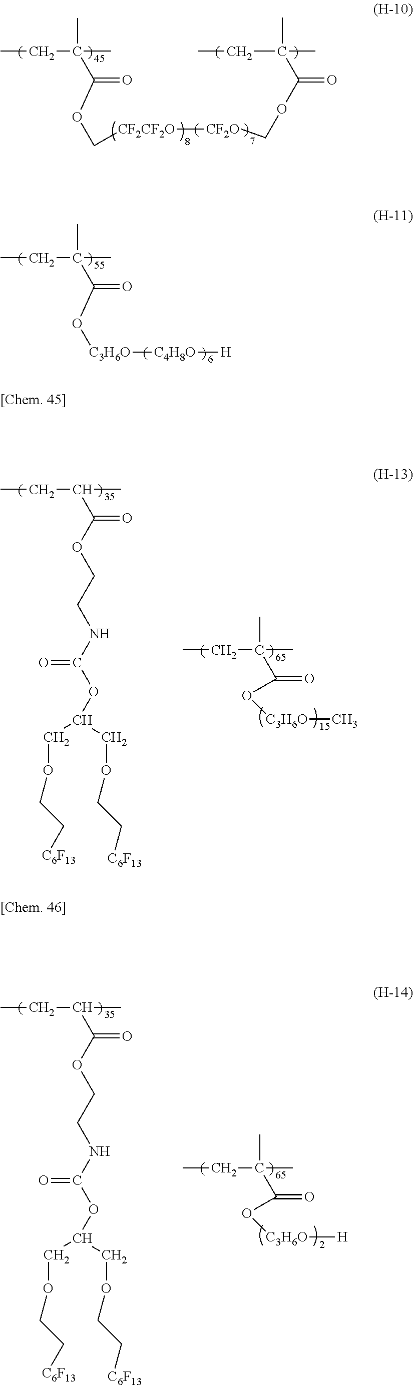

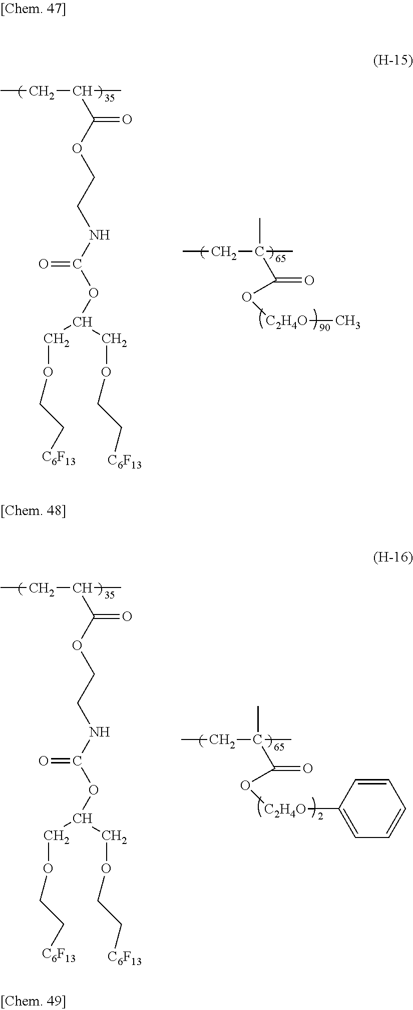

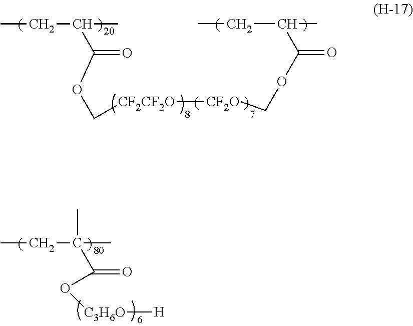

TABLE 5

| | SP value of | | | |
|---|---|---|---|---|
| | polymerizable | | | |
| | monomer of general | Value of | Weight average | |
| | formula (B) | formula (1) | molecular weight | (X)/(B) |
| H-1 | 9.68 | 1.22 | 2,800 | 30/70 |
| H-2 | 9.68 | 1.22 | 9,500 | 30/70 |
| H-3 | 9.15 | 1.89 | 11,000 | 30/70 |
| H-4 | 9.88 | 1.33 | 28,000 | 35/65 |
| H-5 | 9.16 | 1.91 | 7,500 | 25/75 |
| H-6 | 9.88 | 1.33 | 14,500 | 60/40 |
| H-7 | 9.68 | 1.22 | 3,600 | 30/70 |
| H-8 | 9.68 | 1.22 | 11,000 | 30/70 |
| H-9 | 9.68 | 1.22 | 20,000 | 30/70 |
| H-10 | 9.68 | 1.22 | 4,600 | 45/55 |
| H-11 | 9.68 | 1.22 | 7,500 | 45/55 |
| H-12 | 9.88 | 1.33 | 38,000 | 35/65 |
| H-13 | 8.69 | 1.55 | 5,000 | 35/65 |
| H-14 | 11.48 | 1.15 | 3,800 | 35/65 |
| H-15 | 9.36 | 2.22 | 7,000 | 35/65 |
| H-16 | 9.68 | 0.85 | 3,500 | 35/65 |
| H-17 | 10.08 | 1.33 | 4,700 | 20/80 |

(Evaluation of Leveling Properties)

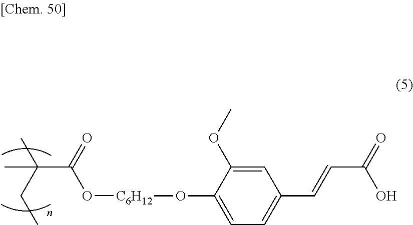

A base material, on which a photo-alignment film was stacked, was produced by coating a TAC film with a photo-alignment polymer denoted by formula (5) described above by using a bar coater, performing drying at 80° C. for 1 minute, and irradiating the coating film having a dry film thickness of 40 nm with visible-ultraviolet light (radiation intensity: 20 mW/cm²), which was linearly polarized light and parallel light, with a wavelength of about 365 nm in the direction perpendicular to the base material by an extra-high pressure mercury lamp through a wavelength cut filter, a band-pass filter, and a polarizing filter (cumulative amount of light: 100 mJ/cm²). Prepared polymerizable liquid crystal composition (1) was applied by a bar coater #4 and was dried at 80° C. for 2 minutes. After being left to stand at room temperature for 15 minutes, the coating film having a dry film thickness of 1.0 μm was irradiated with UV light by using a conveyer type high pressure mercury lamp such that the cumulative amount of light of 500 mJ/cm² was achieved. The manner of cissing of the resulting film was visually observed.

⊙: No cissing defect was observed on the coating film surface.
◯: Very few cissing defects were observed on the coating film surface.
Δ: A few cissing defects were observed on the coating film surface.
x: Many cissing defects were observed on the coating film surface.

(Evaluation of Offset)

On the polymerizable liquid crystal composition surface (A) of the film famed as a sample for evaluating the leveling properties, the same TAC film (B) was stacked. A load of 40 g/cm² was applied and the stacking state was maintained at 80° C. for 30 minutes. Thereafter, cooling to room temperature was performed while the stacking state was maintained. Subsequently, film (B) was peeled, and whether offset of the surfactant in the polymerizable liquid crystal composition to film (B) occurred or not was visually observed. In this regard, in the case where the surfactant was transferred to film (B), an offset portion was observed to be white turbidity.

⊙: Offset was not observed.
◯: Offset was slightly observed.
Δ: Offset was somewhat observed.
x: Offset was entirely observed.

(Evaluation of Alignment Properties)

Prepared polymerizable liquid crystal composition (1) was applied to a TAC (triacetyl cellulose) film at room temperature by a bar coater #4 and was dried at 80° C. for 2 minutes. After being left to stand at room temperature for 15 minutes, the coating film was irradiated with UV light by using a conveyer type high pressure mercury lamp while the cumulative amount of light was set to be 500 mJ/cm². The alignment properties of the resulting film was evaluated visually and by a polarization microscope.

⊙: No defect was visually observed, and no defect was observed by a polarization microscope.
◯: No defect was visually observed, but non-alignment portion was partly observed by a polarization microscope.
Δ: No defect was visually observed, but non-alignment portion was entirely observed by a polarization microscope.
x: Defects were visually partly observed, and non-alignment portion was entirely observed by a polarization microscope.

The results obtained are shown in the following table.

TABLE 6

| | Polymerizable | Evaluation | | Evaluation |
|---|---|---|---|---|
| | liquid crystal | of leveling | Evaluation | of alignment |
| | composition | properties | of offset | properties |
| Example 1 | (1) | ⊙ | ⊙ | ⊙ |
| Example 2 | (2) | ⊙ | ⊙ | ⊙ |
| Example 3 | (3) | ⊙ | ⊙ | ◯ |
| Example 4 | (4) | ⊙ | ◯ | ⊙ |
| Example 5 | (5) | ⊙ | ◯ | ⊙ |
| Example 6 | (6) | ⊙ | ◯ | ⊙ |
| Example 7 | (7) | ⊙ | ⊙ | ⊙ |
| Example 8 | (8) | ⊙ | ◯ | ⊙ |
| Example 9 | (9) | ⊙ | ◯ | ⊙ |
| Example 10 | (10) | ⊙ | ◯ | ⊙ |
| Example 11 | (11) | ⊙ | ◯ | ⊙ |
| Example 12 | (12) | ⊙ | ◯ | ⊙ |
| Example 13 | (13) | ◯ | ⊙ | ⊙ |
| Example 14 | (14) | ⊙ | ⊙ | ⊙ |
| Example 15 | (15) | ⊙ | ⊙ | ⊙ |
| Example 16 | (16) | ⊙ | ⊙ | ⊙ |
| Example 17 | (17) | ⊙ | ⊙ | ⊙ |
| Example 18 | (18) | ⊙ | ⊙ | ⊙ |
| Example 19 | (19) | ⊙ | ⊙ | ⊙ |
| Example 20 | (20) | ⊙ | ⊙ | ⊙ |
| Example 21 | (21) | ⊙ | ⊙ | ⊙ |
| Example 22 | (22) | ⊙ | ⊙ | ⊙ |
| Example 23 | (23) | ⊙ | ⊙ | ⊙ |
| Example 24 | (24) | ⊙ | ⊙ | ⊙ |
| Example 25 | (25) | ⊙ | ⊙ | ⊙ |
| Example 26 | (26) | ⊙ | ⊙ | ⊙ |
| Example 27 | (27) | ⊙ | ⊙ | ⊙ |
| Example 28 | (28) | ⊙ | ⊙ | ⊙ |
| Example 29 | (29) | ⊙ | ◯ | ⊙ |
| Example 30 | (30) | ◯ | ◯ | ⊙ |
| Example 31 | (31) | ⊙ | ◯ | ⊙ |
| Example 32 | (32) | ⊙ | ◯ | ⊙ |
| Example 33 | (33) | ◯ | ◯ | ⊙ |
| Example 34 | (40) | ⊙ | ⊙ | ⊙ |
| Example 35 | (41) | ⊙ | ⊙ | ◯ |
| Example 36 | (42) | ⊙ | ⊙ | ◯ |
| Example 37 | (43) | ⊙ | ⊙ | ◯ |
| Comparative | (34) | ◯ | X | Δ |
| example 1 | | | | |
| Comparative | (35) | Δ | Δ | Δ |
| example 2 | | | | |
| Comparative | (36) | X | Δ | ◯ |
| example 3 | | | | |
| Comparative | (37) | X | Δ | ◯ |
| example 4 | | | | |
| Comparative | (38) | Δ | Δ | ◯ |
| example 5 | | | | |
| Comparative | (39) | Δ | X | X |
| example 6 | | | | |

Polymerizable liquid crystal compositions (2) to (39) and (40) to (43) were used, and the leveling properties, the offset, and the alignment properties were evaluated under the same condition as that for example 1. The results are shown in the table described above. Regarding the substrate of the film for evaluating the leveling properties, the offset, and the alignment properties, the film, in which the photo-alignment polymer denoted by formula (5) described above was stacked as the aligned film on the TAC film base material in the same manner as in example 1, was used in each of examples 2 to 20, examples 29 to 33, examples 36 and 37, and comparative examples 1 to 5. The film, in which silane coupling-based vertically aligned film was stacked on the COP film base material, was used in each of example 22, example 24, examples 26 to 28, and example 35. The COP film base material (without vertically aligned film) was used in each of example 21, example 23, example 25, example 34, and comparative example 6. Meanwhile, a coating film for evaluation was formed by performing coating with the bar coater #4 in each of examples 2 to 28, examples 31 to 37, and comparative examples 1 to 6 in the same manner as in example 1, and a film was formed by performing coating with the bar coater #9 in each of example 29 and example 30.

As a result, regarding the polymerizable liquid crystal compositions (examples 1 to 37) including the surfactants denoted by formula (H-1) to formula (H-11) and formula (H-17), it can be said that all the evaluation of the leveling properties, the evaluation of the offset, and the test results of the alignment properties were good and the productivity was excellent. Among them, in particular, regarding the polymerizable liquid crystal compositions including fluorosurfactants having specific polyoxyalkylene skeletons and specific molecular weights, the evaluation of the leveling properties, the evaluation of the offset, and the test results of the alignment properties were very good. On the other hand, according to the results of comparative examples 1 to 6, in the case where a fluorosurfactant that had a molecular weight out of the specific range and that did not have a specific polyoxyalkylene skeleton was used, one of the evaluation of the leveling properties, the evaluation of the offset, and the test result of the alignment properties was poor. Therefore, the results were inferior to the results of the polymerizable liquid crystal compositions according to the present invention.

1. A polymerizable liquid crystal composition comprising at least one polymerizable compound denoted by a general formula (I) 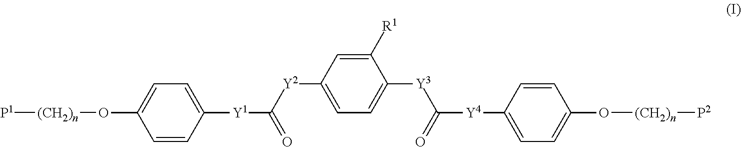
(n represents an integer of 1 to 10, each of P¹ and P² represents an acryloyl group, a methacryloyl group, a vinyl ether group, an aliphatic epoxy group, or an alicyclic epoxy group, each of Y¹, Y², Y³, and Y⁴ represents a single bond, —O—, —CH₂—, —CH₂CH₂—, —OCH₂CH₂—, or —CH₂CH₂O—, and R¹ represents a hydrogen atom, a methyl group, an ethyl group, a methoxy group, an ethoxy group, or —COO—CH₂—C₆H₅) and at least one fluorosurfactant selected from the group consisting of copolymers (III), each of which has a weight average molecular weight of 2,500 to 30,000 and is a copolymer produced by copolymerizing, as indispensable monomers, a polymerizable monomer denoted by a general formula (B), the polymerizable monomer having a solubility parameter (SP value) of 8.9 to 10.5 (cal/cm³)^{0.5} and satisfying a formula (1) described below
1.00<100×(s+t+u)/MB<2.10 (1)
(s represents an integer of 1 or more, each oft and u represents an integer of 0 or more, and MB represents the molecular weight of the polymerizable monomer denoted by the general formula (B))
and a polymerizable monomer containing a fluorine atom 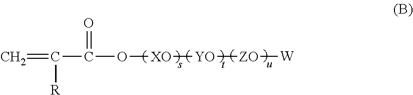
(in the formula, R represents a hydrogen atom or a methyl group, each of X, Y, and Z represents an alkylene group, s represents an integer of 1 or more, each oft and u represents an integer of 0 or more, and W represents a hydrogen atom, an alkyl group having a carbon atom number of 1 to 6, or an aryl group).

2. The polymerizable liquid crystal composition according to claim 1 comprising, as the polymerizable monomer containing a fluorine atom, a polymerizable monomer (A) that has a fluoroalkyl group having a carbon atom number of 4 to 6 (where the alkyl group includes an alkyl group having an ether bond due to an oxygen atom).

3. The polymerizable liquid crystal composition according to claim 1 comprising, as the polymerizable monomer containing a fluorine atom, a polymerizable monomer (D) having a poly(perfluoroalkylene ether) chain and polymerizable unsaturated groups at both ends of the chain.

4. The polymerizable liquid crystal composition according to claim 1 comprising, as the polymerizable compound denoted by the general formula (I), at least one polymerizable compound selected from the group consisting of compounds denoted by a general formula (I-1) 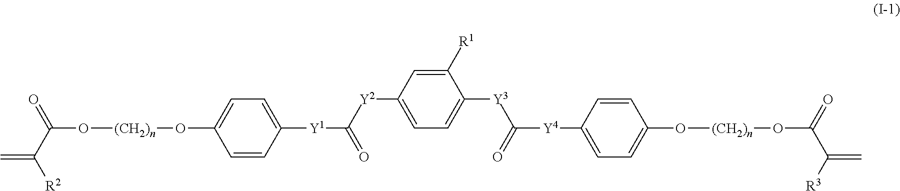
(n represents an integer of 1 to 10, each of Y¹, Y², Y³, and Y⁴ represents a single bond, —O—, —CH₂—, —CH₂CH₂—, —OCH₂CH₂—, or —CH₂CH₂O—, R¹ represents a hydrogen atom, a methyl group, an ethyl group, a methoxy group, an ethoxy group, or —COO—CH₂—C₆H₅, and each of R² and R³ represents a hydrogen atom or a methyl group).

5. The polymerizable liquid crystal composition according to claim 4 comprising, as the polymerizable compound denoted by the general formula (I-1), at least one polymerizable compound selected from the group consisting of compounds denoted by a formula (I-1-1) to a formula (I-1-7).

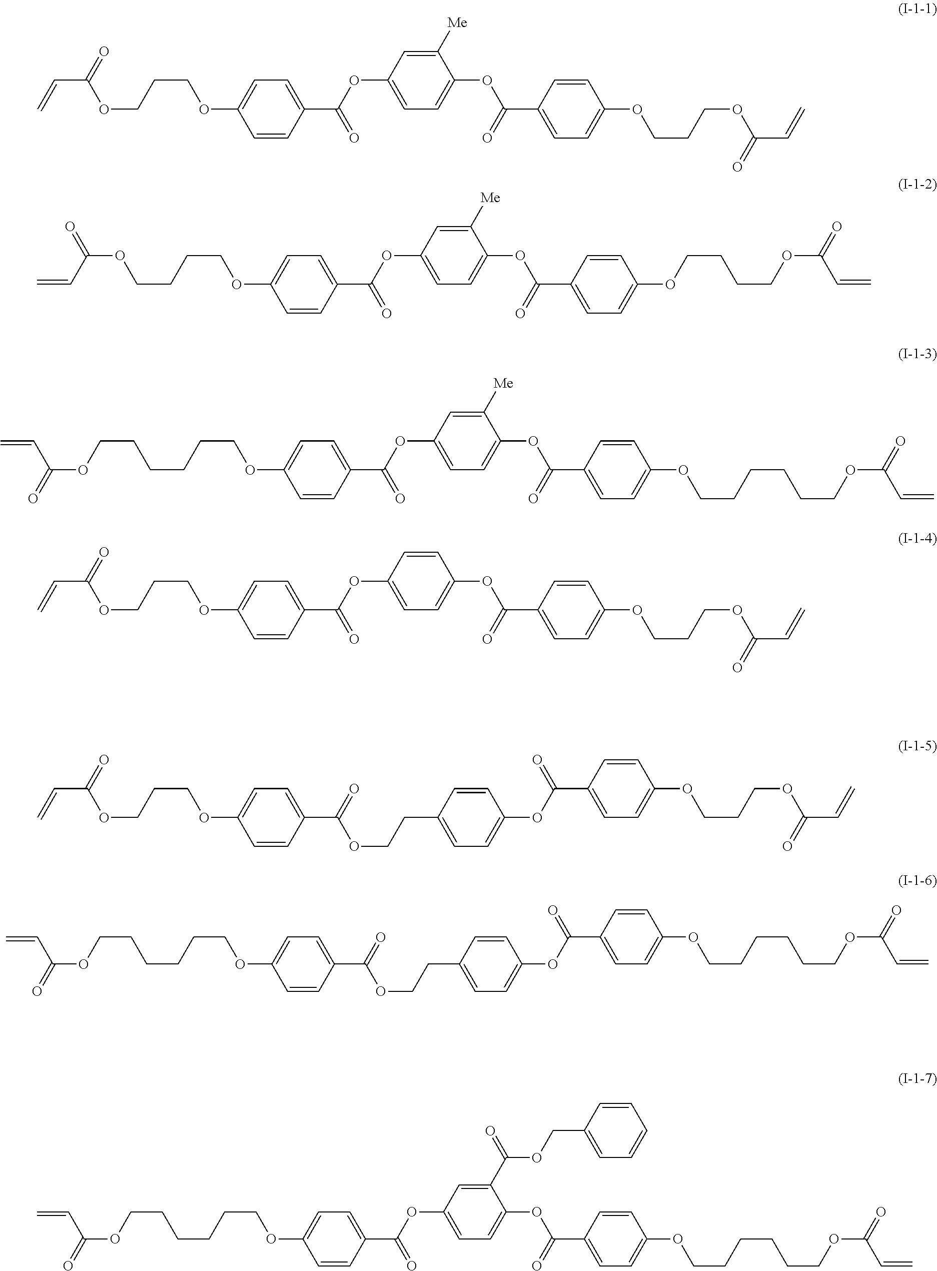

6. An optically anisotropic body comprising the polymerizable liquid crystal composition according to claim 1.

7. A phase difference film comprising the polymerizable liquid crystal composition according to claim 1.

8. An antireflection film comprising the polymerizable liquid crystal composition according to claim 1.

9. A liquid crystal display element comprising the polymerizable liquid crystal composition according to claim 1.
